(19) United States
(12) Patent Application Publication
(10) Pub. No.: US 2020/0207084 A1
(43) Pub. Date: Jul. 2, 2020

(54) FILLING APPARATUS AND FILLING METHOD

(71) Applicant: SEIKO EPSON CORPORATION, Tokyo (JP)

(72) Inventor: Yoichi MIYASAKA, Suwa (JP)

(21) Appl. No.: 16/726,326

(22) Filed: Dec. 24, 2019

(30) Foreign Application Priority Data
Dec. 26, 2018 (JP) 2018-242999

(51) Int. Cl. B41J 2/055; B41J 2/175; B41J 2/17; B41J 2/165

(52) U.S. Cl. CPC B41J 2/055; B41J 2/17506; B41J 2002/16567; B41J 2/16552; B41J 2/1714

(57) ABSTRACT

A filling apparatus that fills a container provided with an interior space, an opening through which the interior space and the outside communicate with each other, and a bottom surface, with a liquid absorber having a water absorbent resin absorbing a liquid, the apparatus includes a stage on which the container is placed, and a vibration applying portion that applies a vibration to the container placed on the stage, in which the vibration is applied as a vibration plane formed in an angle range in which an angle to a horizontal plane is within 0°±30°.

The present application is based on, and claims priority from JP Application Serial Number 2018-242999, filed Dec. 26, 2018, the disclosure of which is hereby incorporated by reference herein in its entirety.

### BACKGROUND

### 1. Technical Field

The present disclosure relates to a filling apparatus and a filling method.

### 2. Related Art

For example, in an ink jet printer, waste ink is normally generated at the time of head cleaning that is performed to prevent a decrease in print quality due to ink clogging or ink filling after ink cartridge replacement. Therefore, in order to prevent such waste ink from unintentionally adhering to a mechanism or the like inside the printer, the ink jet printer is provided with a liquid absorber that absorbs the waste ink.

The liquid absorber is normally filled in a container. As a result, the waste ink supplied into the container can be gradually absorbed by the liquid absorber. Therefore, it is desired to fill the container with the liquid absorber as little gap as possible.

JP-A-2018-61852 discloses a method of filling a particulate water-absorbing agent into a filling container and filling the particulate water-absorbing agent by vibrating the filling container in a vertical direction or a direction of ±30° in the vertical direction. As a result, a filling state with little segregation can be obtained.

On the other hand, in a filling method described in JP-A-2018-61852, there is a problem that it takes a long time to uniformly fill the water-absorbing agent. Specifically, when the water-absorbing agent is charged into the container, it is a heaped state from a charging position. Thereafter, when vibration is applied in the vertical direction as described in JP-A-2018-61852, although the water-absorbing agent gradually spreads, there is a problem that it takes a long time to fill all corners of the container.

### SUMMARY

The present disclosure can be realized in the following aspects.

According to an aspect of the present disclosure, there is provided a filling apparatus that fills a container provided with an interior space, an opening through which the interior space and the outside communicate with each other, and a bottom surface, with a liquid absorber having a water absorbent resin absorbing a liquid, the apparatus including a stage on which the container is placed, and a vibration applying portion that applies a vibration to the container placed on the stage, in which the vibration is applied as a vibration plane formed in an angle range in which an angle to a horizontal plane is within 0°±30°.

According to an aspect of the present disclosure, there is provided a filling method of filling a container provided with an interior space, an opening through which the interior space and the outside communicate with each other, and a bottom surface, with a liquid absorber having a water absorbent resin absorbing a liquid, the method including a charging step of charging the liquid absorber from the opening toward the interior space, and a vibration step of applying a vibration to the container in which the liquid absorber is charged, in which the vibration is applied to the container as a vibration plane formed in an angle range in which an angle to a horizontal plane is within 0°±30° in the vibration step.

### BRIEF DESCRIPTION OF THE DRAWINGS

FIG. 1 is a cross-sectional view of a filling apparatus according to a first embodiment when cut along a plane parallel to a vertical direction.

FIG. 2 is a top view of the filling apparatus illustrated in FIG. 1 when viewed from vertically above.

FIG. 3 is a diagram illustrating a relationship between a bottom surface of a container illustrated in FIG. 2 and a translation vector representing vibration applied by a vibration applying portion.

FIG. 4 is another diagram illustrating a relationship between the bottom surface of the container illustrated in FIG. 2 and a translation vector representing the vibration applied by the vibration applying portion.

FIG. 5 is still another diagram illustrating a relationship between the bottom surface of the container illustrated in FIG. 2 and directions of vibration applied by the vibration applying portion.

FIG. 6 is a flowchart illustrating a filling method according to the first embodiment.

FIG. 7 is a view for describing the filling method illustrated in FIG. 6.

FIG. 8 is a view for describing the filling method illustrated in FIG. 6.

FIG. 9 is a cross-sectional view of a filling apparatus according to a second embodiment when cut along a plane parallel to a vertical direction.

FIG. 10 is a view illustrating a liquid absorber illustrated in FIG. 9.

FIG. 11 is a view illustrating the liquid absorber illustrated in FIG. 9.

FIG. 12 is a view illustrating the liquid absorber illustrated in FIG. 9.

FIG. 13 is a diagram for describing an example of a method of manufacturing the liquid absorber illustrated in FIGS. 11 and 12.

FIG. 14 is a diagram for describing an example of a method of manufacturing the liquid absorber illustrated in FIGS. 11 and 12.

FIG. 15 is a diagram for describing an example of a method of manufacturing the liquid absorber illustrated in FIGS. 11 and 12.

FIG. 16 is a view illustrating a modification example of the liquid absorber illustrated in FIGS. 11 and 12.

FIG. 17 is a view illustrating a modification example of the liquid absorber illustrated in FIGS. 11 and 12.

FIG. 18 is a view illustrating a modification example of the liquid absorber illustrated in FIGS. 11 and 12.

FIG. 19 is a view for describing a filling method by the filling apparatus illustrated in FIG. 9.

FIG. 20 is a view for describing a filling method by the filling apparatus illustrated in FIG. 9.

FIG. 21 is a cross-sectional view of a filling apparatus according to a third embodiment when cut along a plane parallel to a vertical direction.

FIG. 22 is a top view of the filling apparatus illustrated in FIG. 21 when viewed from vertically above.

FIG. 23 is a view for describing a filling method according to the third embodiment.

FIG. 24 is a view for describing a filling method according to the third embodiment.

FIG. 25 is a cross-sectional view of a filling apparatus according to a fourth embodiment when cut along a plane parallel to a vertical direction.

FIG. 26 is a cross-sectional view of a filling apparatus according to a fifth embodiment when cut along a plane parallel to a vertical direction.

### DESCRIPTION OF EXEMPLARY EMBODIMENTS

Hereinafter, a filling apparatus and a filling method of the present disclosure will be described in detail based on preferred embodiments illustrated in the accompanying drawings.

### First Embodiment

First, a first embodiment will be described.

### Filling Apparatus

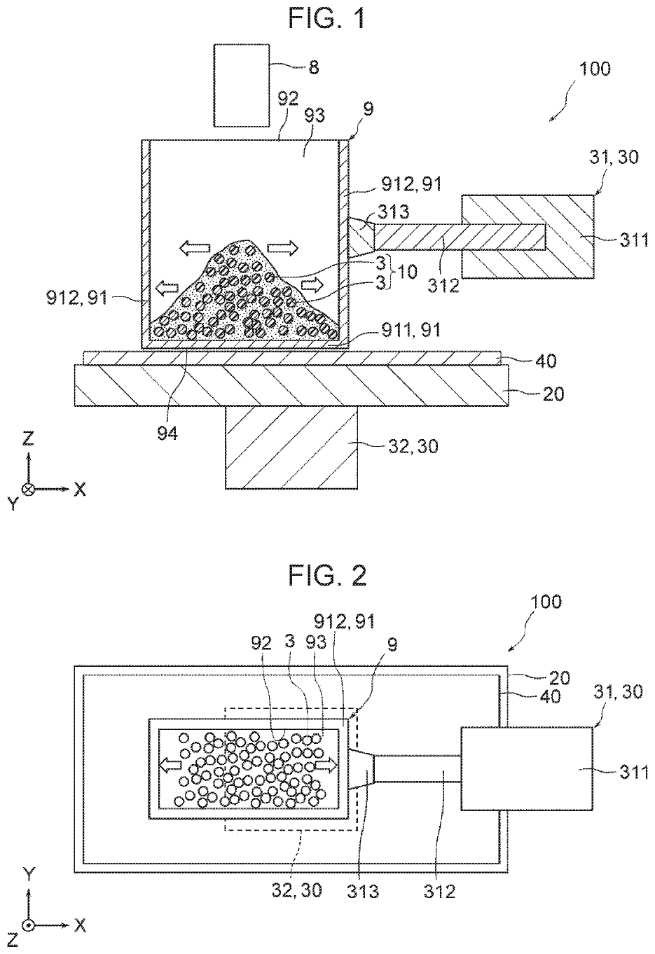

FIG. 1 is a cross-sectional view of a filling apparatus according to the first embodiment when cut along a plane parallel to a vertical direction. FIG. 2 is a top view of the filling apparatus illustrated in FIG. 1 when viewed from vertically above.

A filling apparatus 100 illustrated in FIG. 1 includes a stage 20 and a vibration applying portion 30. A container 9 is placed on the stage 20. In addition, the container 9 is charged with a liquid absorber 10. The filling apparatus 100 is used to fill the container 9 with the liquid absorber 10.

Here, first, the container 9 will be described prior to a description of the filling apparatus 100.

The container 9 is a container storing the liquid absorber 10. The liquid absorber 10 is a material having a capability to absorb liquid, and holds the absorbed liquid. Therefore, by storing the liquid absorber 10 in the container 9, the liquid supplied to the container 9 can be held, so that the liquid can be prevented from spilling or splashing around.

The container 9 illustrated in FIG. 1 includes an interior space 93 defined by a wall portion 91, and an opening 92 that allows the interior space 93 to communicate with the outside. The interior space 93 surrounded by the wall portion 91 is a bottomed space storing the liquid absorber 10 and storing the liquid. In addition, a lower surface of the wall portion 91 is a bottom surface 94 of the container 9. The container 9 is self-supporting by abutting the bottom surface 94 on the stage 20. Whether or not the container 9 is self-supporting in this manner is not particularly limited. For example, the container 9 may be supported by the filling apparatus 100 so as not to fall down.

When viewed from the vertical direction, the bottom surface 94 illustrated in FIG. 1 has a rectangular shape having a major axis in a left-right direction in FIG. 2 as illustrated in FIG. 2. The shape of the bottom surface 94 is not particularly limited, and may be a shape other than a rectangle, for example, a square, may be a polygon such as a parallelogram, a pentagon, or a hexagon, may be a circle such as a perfect circle, an ellipse, or an ellipse, or may be an irregular shape.

The wall portion 91 includes a bottom portion 911 having the bottom surface 94 as a main surface on a vertically lower side, and a side portion 912 erected upward from an edge of the bottom portion 911. A region surrounded by the upper end of the side portion 912 corresponds to the upper end of the interior space 93, and is the opening 92 communicating the interior space 93 with the outside.

The filling apparatus 100 according to the present embodiment efficiently moves the liquid absorber 10 in the interior space 93 by applying vibration to the container 9, so that the filling apparatus 100 is an apparatus for filling the entire interior space 93 with the liquid absorber 10 uniformly and in a short time.

As will be described in detail later, the liquid absorber 10 includes a water absorbent resin capable of absorbing liquid. The form of the liquid absorber 10 has a particulate form.

Such a liquid absorber 10 has low fluidity. Therefore, in order to fill the container 9 with the liquid absorber 10, it is required to efficiently move the liquid absorber 10 by the filling apparatus 100.

Next, each part of the filling apparatus 100 will be described.

The stage 20 is a member that supports the bottom surface 94 of the container 9. The shape of the stage 20 is not particularly limited, and is, for example, a plate shape.

The constituent material of the stage 20 is not particularly limited as long as it is a material having rigidity capable of supporting the container 9, and examples thereof include a metal material, a ceramic material, and a resin material.

In addition, the filling apparatus 100 according to the present embodiment is provided with a sheet 40 interposed between the stage 20 and the container 9. Therefore, the stage 20 illustrated in FIG. 1 supports the bottom surface 94 of the container 9 via the sheet 40.

The sheet 40 is made of a material having a relatively small friction coefficient with respect to the bottom surface 94 of the container 9. Specifically, the constituent material of the sheet 40 includes a resin material such as a fluorine resin and a silicone resin, a carbon material such as graphite, and the like. By providing such a sheet 40, the sliding resistance of the container 9 with respect to the sheet 40 can be lowered, and the container 9 placed on the sheet 40 slides smoothly even with a small force.

The sheet 40 may be provided as necessary, and for example, when the friction coefficient of the front surface of the stage 20 is small, the sheet 40 may be omitted. In addition, instead of the sheet 40, a surface treatment such as forming a thin film or processing irregularities may be performed so as to reduce the friction coefficient of the front surface of the stage 20.

The sizes of the stage 20 and the sheet 40 when viewed from the vertical direction are not particularly limited, and are preferably sizes that can support the entire bottom surface 94. In addition, considering that the front surface of the sheet 40 is slid by the vibration applying portion 30 described later, it is further preferable that the size exceeds the extension of the sliding.

The vibration applying portion 30 illustrated in FIGS. 1 and 2 applies vibration to the container 9 placed on the stage 20. The upper surface of the stage 20 according to the present embodiment is parallel to the horizontal plane. In addition, in FIGS. 1 and 2, three axes orthogonal to each other are defined as an X axis, a Y axis, and a Z axis. An axis orthogonal to the upper surface of the stage 20, that is, a vertical axis is defined as the Z axis, and two axes orthogonal to each other in the upper surface of the stage 20, that is, the horizontal plane, are defined as the X axis and the Y axis. Therefore, the embodiment is an example in which the bottom surface 94 of the container 9 is parallel to the X-Y plane and parallel to the horizontal plane.

The vibration applying portion 30 is provided with a first axial direction vibration portion 31 that applies vibration so that the container 9 reciprocates in the X axis direction, and a second axial direction vibration portion 32 that applies vibration so that the container 9 reciprocates in the Y axis direction.

Among these, the first axial direction vibration portion 31 is provided with a first axis cylinder 311, a rod 312 that reciprocates in the X axis direction by the driving force generated by the first axis cylinder 311, and a suction pad 313 provided at the tip end of the rod 312 and sucked into the container 9. The first axis cylinder 311 reciprocally drives the rod 312 partially inserted into the first axis cylinder 311 in the X axis direction, for example, by changing air pressure or hydraulic pressure. The suction pad 313 is provided at the tip end of the rod 312 and is configured to include a suction cup sucked into the container 9.

When the container 9 is vibrated by the first axial direction vibration portion 31, the container 9 slides on the sheet 40. The liquid absorber 10 charged in the container 9 can be vibrated in the X axis direction.

The structure of the first axial direction vibration portion 31 is not limited thereto, as long as the container 9 is vibrated in the X axis direction.

On the other hand, the second axial direction vibration portion 32 is provided below the stage 20 and vibrates the container 9 with the stage 20. Although the second axial direction vibration portion 32 is not illustrated, and for example, is provided with a support portion that supports the lower surface of the stage 20, a second axis cylinder similar to the first axial direction vibration portion 31 described above, and a rod having a support portion attached to the tip end. The rod is reciprocated in the Y axis direction by the driving force generated by the second axis cylinder, and the support portion, the stage 20, and the container 9 are reciprocated in the Y axis direction accordingly.

When the container 9 is vibrated by the second axial direction vibration portion 32, the liquid absorber 10 charged in the container 9 can be vibrated in the Y axis direction.

The structure of the second axial direction vibration portion 32 is not limited thereto, as long as the container 9 is reciprocated in the Y axis direction.

Here, when the container 9 is filled with the liquid absorber 10, first, the liquid absorber 10 is fallen from a feeder 8 disposed above the opening 92 of the container 9 and charged. As a result, as illustrated in FIG. 1, for example, the liquid absorber 10 is accumulated in a heaped state with an apex directly below the feeder 8. Thereafter, when the container 9 is vibrated, the liquid absorber 10 moves as indicated by an arrow illustrated in FIG. 1, and finally the container 9 is uniformly filled with the liquid absorber 10.

In order to perform this filling in a shorter time, in the vibration applying portion 30 according to the present embodiment, vibration having a horizontal plane as a vibration plane is applied to the container 9. Such vibration promotes the movement of the liquid absorber 10 in the horizontal direction. Therefore, the liquid absorber 10 can be spread over the interior space 93 of the container 9 in a short time.

The vibration plane of the vibration applied by the vibration applying portion 30 may be a plane slightly inclined with respect to the horizontal plane, in addition to the horizontal plane. Specifically, since the above-described stage 20 is an example in which the upper surface thereof is a horizontal plane, the vibration plane is parallel to the horizontal plane. On the other hand, the above-described effect can be obtained even when a plane in which an angle to the horizontal plane is 30° or less is the vibration plane. In other words, the angle between the horizontal plane and the vibration plane may be 30° or less. When the vibration plane is within such an angle range, vibration including a component that is relatively close to the horizontal direction is applied, so that the liquid absorber 10 is likely to move in the horizontal direction. As a result, the liquid absorber 10 can be spread over the entire interior space 93 in a relatively short time.

In the vertical direction, gravity acts on the liquid absorber 10, and thus the liquid absorber 10 is likely to move even when vibration is not applied. Therefore, the opening 92 may be provided at a vertical upper end of the interior space 93.

In addition, the vibration plane is preferably a plane in which an angle to the horizontal plane is 20° or less, and more preferably a plane in which an angle to the horizontal plane is 10° or less.

When this angle exceeds the above upper limit value, the liquid absorber 10 is difficult to move in the horizontal direction, so that the liquid absorber 10 continues to stay directly above in the vicinity of the center of the bottom surface 94 of the container 9, for example. Therefore, a portion that is not filled with the liquid absorber 10 is generated in the interior space 93, and there is a possibility a filling rate may decrease.

As described above, the filling apparatus 100 according to the present embodiment is an apparatus that fills the container 9 provided with the interior space 93, the opening 92 through which the interior space 93 communicates with the outside, and the bottom surface 94 with the liquid absorber 10 having a water absorbent resin capable of absorbing liquid. The filling apparatus 100 includes the stage 20 on which the container 9 is placed, and the vibration applying portion 30 that applies vibration to the container 9 placed on the stage 20. The vibration applied by the vibration applying portion 30 is applied as a vibration plane formed in an angle range in which an angle to the horizontal plane is within 0°±30°.

According to such a filling apparatus 100, the liquid absorber 10 can be uniformly filled efficiently and in a short time. As a result, the liquid absorber 10 can be filled at a high filling rate.

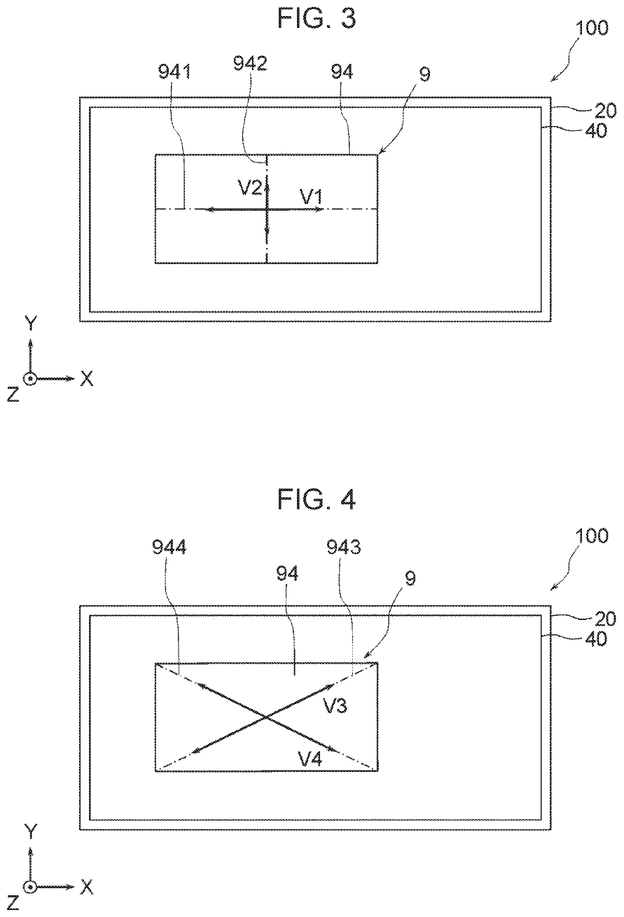

Here, FIG. 3 is a diagram illustrating the relationship between the bottom surface 94 of the container 9 illustrated in FIG. 2 and a displacement direction of the liquid absorber 10 due to vibration applied by the vibration applying portion 30.

In the example illustrated in FIG. 3, the first axial direction vibration portion 31 applies a first axis vibration in a direction parallel to a major axis 941 of the rectangular bottom surface 94 to the container 9. The second axial direction vibration portion 32 applies a second axis vibration in a direction parallel to a minor axis 942 of the rectangular bottom surface 94 to the container 9. That is, in FIG. 3, a translation vector V1 representing the first axis vibration is positioned parallel to the major axis 941 of the bottom surface 94, and a translation vector V2 representing the second axis vibration is positioned parallel to the minor axis 942 of the bottom surface 94. These vectors represent the direction and amplitude in which the liquid absorber 10 is displaced depending on the direction and length.

In the example illustrated in FIG. 3, such first axis vibration and second axis vibration are applied in different time zones from each other. That is, the vibration applying portion 30 applies the first axis vibration (vibration in the first direction) and the second axis vibration (vibration in the second direction) in a time division manner. As a result, for example, in the case of the container 9 provided with the bottom surface 94 having a rectangular shape, the liquid absorber 10 swings alternately in the direction of the major axis 941 and the direction of the minor axis 942 of the bottom surface 94. As a result, since the liquid absorber 10 moves alternately in each direction, the liquid absorber 10 can be filled in a shorter time.

In addition, when the translation vector V1 representing the first axis vibration is projected onto the bottom surface 94, the angle formed by the major axis 941 (main axis of inertia) of the bottom surface 94 and the translation vector V1 is 0° in FIG. 3. That is, an extending direction of the major axis 941 of the bottom surface 94 coincides with the direction of the translation vector V1.

However, a slight deviation is allowed between the major axis 941 of the bottom surface 94 and the translation vector V1. Specifically, this angle is preferably 30° or less, and more preferably 20° or less. By setting the arrangement of the container 9 with respect to the filling apparatus 100, that is, the arrangement of the container 9 with respect to the translation vector V1 in this manner, the liquid absorber 10 can be efficiently swung along the major axis 941 of the bottom surface 94. As a result, even when the bottom surface 94 of the container 9 has a shape with large anisotropy, for example, when the bottom surface 94 is an elongated rectangle, the liquid absorber 10 can be efficiently filled.

FIG. 4 is another diagram illustrating a relationship between the bottom surface 94 of the container 9 illustrated in FIG. 2 and a translation vector representing the vibration applied by the vibration applying portion 30.

In the example illustrated in FIG. 4, similarly to in FIG. 3, the first axial direction vibration portion 31 applies a first axis vibration in a direction parallel to a major axis 941 of the rectangular bottom surface 94 to the container 9. The second axial direction vibration portion 32 applies a second axis vibration in a direction parallel to a minor axis 942 of the rectangular bottom surface 94 to the container 9.

In the example illustrated in FIG. 4, the first axis vibration and the second axis vibration are applied in the same time zone. That is, the vibration applying portion 30 simultaneously applies the first axis vibration (vibration in the first direction) and the second axis vibration (vibration in the second direction). As a result, for example, in the case of the container 9 provided with the rectangular bottom surface 94, the liquid absorber 10 swings in the extending direction of diagonal lines 943 and 944 of the bottom surface 94. Specifically, in the example illustrated in FIG. 4, the above-described translation vector V1 representing the first axis vibration and the translation vector V2 representing the second axis vibration are combined to generate a combined vibration, and the combined vibration is represented by a combined vector V3 or a combined vector V4. Since the liquid absorber 10 moves in the extending direction of the diagonal line 943 or the diagonal line 944 of the bottom surface 94 by the combined vibration, the interior space 93 can be filled with the liquid absorber 10 in a shorter time.

As described above, although the combined vectors V3 and V4 representing the combined vibration are obtained by combining the translation vector V1 and the translation vector V2, respectively, by appropriately changing a phase of the first axis vibration represented by the translation vector V1 and a phase of the second axis vibration represented by the translation vector V2, the combined vibration represented by the combined vector V3 or the combined vibration represented by the combined vector V4 can be generated.

In addition, by appropriately changing the lengths of the translation vectors V1 and V2, that is, by appropriately changing the amplitudes of the first axis vibration and the second axis vibration, the length and direction of the combined vectors V3 and V4 representing the combined vibration, that is, the amplitude and the vibration direction of the combined vibration can be controlled.

In order to change each amplitude of the first axis vibration and the second axis vibration, for example, a stroke of the rod 312 of the first axial direction vibration portion 31 and a stroke of the rod of the second axial direction vibration portion 32 may be changed.

The bottom surface 94 illustrated in FIG. 4 has a quadrangular shape as described above. When the combined vectors V3 and V4 of the translation vector V1 and the translation vector V2 are projected onto the bottom surface 94, the angle formed between the diagonal line 943 of the bottom surface 94 and the combined vector V3 and the angle formed between the diagonal line 944 of the bottom surface 94 and the combined vector V4 are 0° in FIG. 4. That is, the extending direction of the diagonal line 943 and the direction of the combined vector V3 are matched, or the extending direction of the diagonal line 944 and the direction of the combined vector V4 are matched.

However, some deviation is allowed between these. Specifically, the angle formed between the diagonal line 943 of the bottom surface 94 and the combined vector V3 and the angle formed between the diagonal line 944 of the bottom surface 94 and the combined vector V4 are preferably 30° or less, and more preferably 20° or less. By setting the arrangement of the container 9 with respect to the combined vector V3 and V4 in this manner, the liquid absorber 10 can be efficiently swung in the extending direction of the diagonal lines 943 and 944 of the bottom surface 94. As a result, the liquid absorber 10 can be efficiently filled in a shorter time. The bottom surface 94 is not limited to a quadrangle, and may be a predetermined polygon having a diagonal line.

In addition, the vibration applying portion 30 preferably and alternately repeats a first vibration pattern that applies the first axis vibration (vibration in the first direction) and the second axis vibration (vibration in the second direction) in a time division manner, and a second vibration pattern that simultaneously applies first axis vibration and the second axis vibration alternately. By changing the vibration pattern in this manner, for example, it is possible to prevent the liquid absorber 10 from unintentionally gathering in a portion of the container 9 and reducing fluidity. That is, when a certain vibration pattern continues, although there is a possibility that a portion where the bulk density of the liquid absorber 10 may unintentionally increase depending on the shape of the container 9, the occurrence of such a portion can be suppressed by changing the vibration pattern. As a result, the liquid absorber 10 can be efficiently filled in a shorter time.

In addition, the vibration pattern may be a pattern of only the first axis vibration or a pattern of only the second axis vibration.

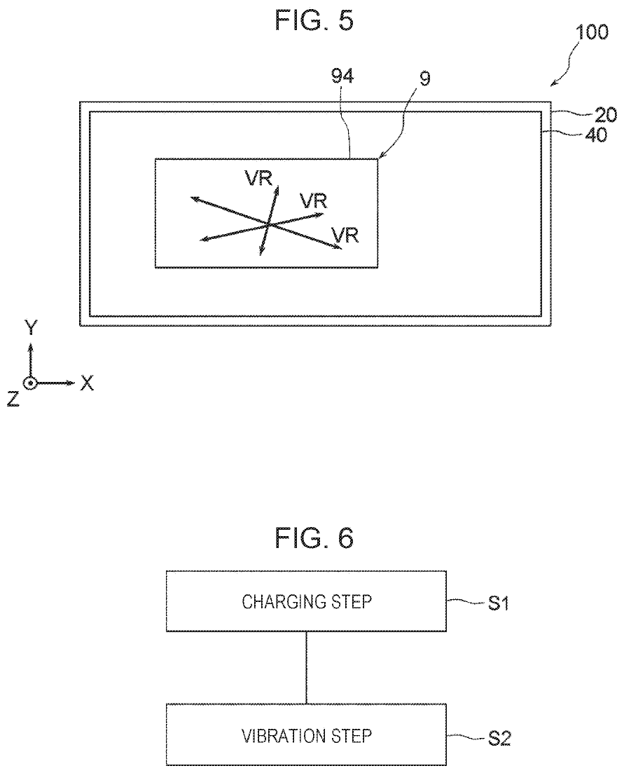

FIG. 5 is still another diagram illustrating a relationship between the bottom surface 94 of the container 9 illustrated in FIG. 2 and directions of vibration applied by the vibration applying portion 30.

In the example illustrated in FIG. 5, when combining the translation vector V1 and the translation vector V2, the length of at least one of the translation vector V1 and the translation vector V2 is changed for each cycle. Specifically, at least one of the stroke of the rod 312 of the first axial direction vibration portion 31 and the stroke of the rod of the second axial direction vibration portion 32 is changed. As a result, a combined vector VR obtained by combining the translation vectors V1 and V2 has a different direction and length for each cycle. That is, the vibration applied to the liquid absorber 10 is a vibration having a different direction and amplitude for each cycle. As a result, the vibration applying portion 30 can apply a vibration whose vibration direction and amplitude change randomly to the container 9. Such vibration can cause the liquid absorber 10 particularly difficult to be unevenly distributed, so that the liquid absorber 10 can be filled particularly efficiently in a shorter time.

The length of at least one of the translation vector V1 and the translation vector V2 may be changed every cycle as described above or every two cycles or more. That is, at least one of the stroke of the rod 312 of the first axial direction vibration portion 31 and the stroke of the rod of the second axial direction vibration portion 32 may be changed every cycle or every two cycles or more.

In addition, the first axis vibration represented by the translation vector V1 and the second axis vibration represented by the translation vector V2 may be synchronized with each other or asynchronous with each other. When synchronized with each other, that is, when the frequency of the first axis vibration and the frequency of the second axis vibration are the same as each other and the phases are the same as each other, the combined vector VR can be inclined with respect to both the major axis 941 and the minor axis 942 of the bottom surface 94. At that time, by changing the lengths of the translation vectors V1 and V2 at random, the direction of the combined vector VR also changes at random. Therefore, although the frequency is constant, it is possible to generate a vibration whose vibration direction and amplitude change at random in the vibration plane. On the other hand, when being asynchronous with each other, it is possible to generate a vibration whose frequency, vibration direction, and amplitude change at random.

The frequency, vibration direction, and amplitude do not necessarily change at random, and may change based on predetermined regularity.

In addition, when applying the first axis vibration and the second axis vibration asynchronously with each other, the vibration applying portion 30 may be configured to include the first axial direction vibration portion 31 and the second axial direction vibration portion 32 as described above, and for example, may be to lift the stage 20 with air pressure. In this configuration, since the stage 20 floats in the air, the stage 20 swings randomly in the horizontal plane in the floating state. Therefore, as a result, the first axis vibration and the second axis vibration can be applied to the container 9 asynchronously.

In FIGS. 1 and 2, since the direction of the first axis vibration (first direction) is the X axis direction and the direction of the second axis vibration (second direction) is the Y axis direction, although the first direction and the second direction is orthogonal to each other, the intersection angle between the first direction and the second direction is not particularly limited, and may be greater than 0° and less than 90°. However, from the viewpoint of efficiently generating vibrations represented by combined vectors in various directions, the intersection angle between the first direction and the second direction is preferably 45° or more and 90° or less, and more preferably 60° or more and 90° or less.

In addition, as described above, the vibration plane is a plane formed in an angle range in which an angle to the horizontal plane is within 0°±30°. For example, when the angle between the vibration plane and the horizontal plane is in the range of greater than 0° and 30° or less, the entire filling apparatus 100 may be tilted, whereby the upper surface of the stage 20 may be tilted with respect to the horizontal plane. In addition to the first axial direction vibration portion 31 and the second axial direction vibration portion 32, a third axial direction vibration portion that applies vibration so that the container 9 reciprocates in the Z axis direction may be provided. In the latter case, the plane including the combined vector, that is, the vibration plane of the combined vibration may satisfy the angle range described above. Furthermore, there may be a time zone only for vibrations that reciprocate in the Z axis direction, and even in that case, a time zone for applying vibration on the vibration plane that satisfies the angle range described above may be provided.

### Liquid Absorber

As illustrated in FIG. 1 or FIG. 2, the liquid absorber 10 contains a water absorbent resin 3 having a plurality of particles.

Such a liquid absorber 10 can change a shape freely. Therefore, a desired amount can be stored in the container 9. As a result, it is possible to prevent unevenness in the liquid absorption characteristics.

In the present specification, “water absorption” means absorption of a liquid such as an aqueous solvent or an organic solvent.

The water absorbent resin 3 is not particularly limited as long as it is a resin having water absorbency. Examples thereof include carboxymethyl cellulose, polyacrylic acid, polyacrylamide, starch-acrylic acid graft copolymer, hydrolyzate of starch-acrylonitrile graft copolymer, vinyl acetate-acrylic acid ester copolymer, hydrolyzate of acrylonitrile copolymer and acrylamide copolymer, such as copolymer of isobutylene and maleic acid, polyethylene oxide, polysulfonic acid compounds, polyglutamic acid, and these salts, neutralized products or cross-linked products. Here, the water absorption means a function having hydrophilicity and retaining moisture. The water absorbent resin 3 may be gelled by absorbing water.

Among these, the water absorbent resin 3 is preferably a resin having a functional group in the side chain. Examples of the functional group include an acid group, a hydroxyl group, an epoxy group, and an amino group.

In particular, the water absorbent resin 3 is preferably a resin having an acid group in the side chain, and more preferably a resin having a carboxyl group in the side chain.

Examples of the carboxyl group-containing unit constituting the side chain include acrylic acid, methacrylic acid, itaconic acid, maleic acid, crotonic acid, fumaric acid, sorbic acid, cinnamic acid, and those derived from monomers such as these anhydrides and salts.

When the water absorbent resin 3 having an acid group in the side chain is included, the ratio of the acid groups contained in the water absorbent resin 3 that are neutralized to form a salt is preferably 30 mol % or more and 100 mol % or less, more preferably 50 mol % or more and 95 mol % or less, still more preferably 60 mol % or more and 90 mol % or less, and most preferably 70 mol % or more and 80 mol % or less. As a result, the liquid absorptivity by the water absorbent resin 3 can be made more excellent.

The type of the salt for neutralization is not particularly limited, and examples thereof include alkali metal salts such as sodium salt, potassium salt, and lithium salt, and salts of nitrogen-containing basic substances such as ammonia. Among these, sodium salt is preferable. As a result, the liquid absorptivity by the water absorbent resin 3 can be made more excellent.

The water absorbent resin 3 having an acid group in the side chain is preferable because an electrostatic repulsion between acid groups occurs during ink absorption and the absorption speed increases. In addition, when the acid group is neutralized, the liquid is easily absorbed into the water absorbent resin 3 by the osmotic pressure.

The water absorbent resin 3 may have a structural unit that does not contain an acid group in the side chain. Examples of such a structural unit include a hydrophilic structural unit, a hydrophobic structural unit, and a structural unit serving as a polymerizable crosslinking agent.

Examples of the hydrophilic structural unit include structural units derived from nonionic compounds such as acrylamide, methacrylamide, N-ethyl (meth) acrylamide, N-n-propyl (meth) acrylamide, N-isopropyl (meth) acrylamide, N, N-dimethyl (meth) acrylamide, 2-hydroxyethyl (meth) acrylate, 2-hydroxypropyl (meth) acrylate, methoxypolyethylene glycol (meth) acrylate, polyethylene glycol mono (meth) acrylate, N-vinylpyrrolidone, N-acryloylpiperidine, and N-acryloylpyrrolidine. In the present specification, (meth) acryl and (meth) acrylate mean acrylic or methacrylic, and acrylate or methacrylate.

Examples of the hydrophobic structural unit include structural units derived from compounds such as (meth) acrylonitrile, styrene, vinyl chloride, butadiene, isobutene, ethylene, propylene, stearyl (meth) acrylate, and lauryl (meth) acrylate.

Examples of the structural unit serving as the polymerizable crosslinking agent include structural units derived from diethylene glycol diacrylate, N, N′-methylenebis acrylamide, polyethylene glycol diacrylate, polypropylene glycol diacrylate, trimethylol propane diallyl ether, trimethylol propane triacrylate, allyl glycidyl ether, pentaerythritol triallyl ether, pentaerythritol diacrylate monostearate, bisphenol diacrylate, isocyanuric acid diacrylate, tetraallyloxy ethane, diallyloxy acetate, and the like.

The water absorbent resin 3 preferably contains a polyacrylate copolymer or a polyacrylic acid polymerized crosslinked product. As a result, there are advantages that the absorption performance with respect to a liquid improves or manufacturing cost is suppressed, for example.

As the polyacrylic acid polymer crosslinked product, the ratio of the structural unit having a carboxyl group in all the structural units constituting the molecular chain is preferably 50 mol % or more, more preferably 80 mol % or more, and still more preferably 90 mol % or more. When the ratio of the structural unit containing a carboxyl group is too small, it may be difficult to make the liquid absorption performance sufficiently excellent.

The carboxyl group in the polyacrylic acid polymer crosslinked product is preferably partially neutralized, that is, partially neutralized to form a salt. The ratio of the neutralized occupying in all the carboxyl groups in the polyacrylic acid polymer crosslinked product is preferably 30 mol % or more and 99 mol % or less, more preferably 50 mol % or more and 99 mol % or less, and still more preferably 70 mol % or more and 99 mol % or less.

In addition, the water absorbent resin 3 may have a structure crosslinked with a crosslinking agent other than the polymerizable crosslinking agent described above.

When the water absorbent resin 3 is a resin having an acid group, as the crosslinking agent, for example, a compound having a plurality of functional groups that react with an acid group can be preferably used.

When the water absorbent resin 3 is a resin having a functional group that reacts with an acid group, a compound having the plurality of functional groups that react with an acid group in the molecule can be suitably used as the crosslinking agent.

Examples of the compound having the plurality of functional groups that react with an acid group include glycily ether compound such as ethylene glycol diglycidyl ether, trimethylolpropane triglycidyl ether, (poly) glycerin polyglycidyl ether, diglycerin polyglycidyl ether, propylene glycol diglycidyl ether; polyhydric alcohols such as (poly) glycerin, (poly) ethylene glycol, propylene glycol, 1,3-propanediol, polyoxyethylene glycol, triethylene glycol, tetraethylene glycol, diethanolamine, triethanolamine; polyhydric amines such as ethylenediamine, diethylenediamine, polyethyleneimine, and hexamethylenediamine. In addition, polyhydric ions such as zinc, calcium, magnesium, and aluminum can be suitably used because these react with the acid groups of the water absorbent resin 3 and function as a crosslinking agent.

The water absorbent resin 3 may have any shape such as a scale form, a needle form, a fiber form, and a particulate form, and preferably has a particulate form. When the water absorbent resin 3 has the particulate form, the liquid permeability can be easily ensured. In addition, the water absorbent resin 3 can be suitably carried on a fiber base material 2. The particulate form means a form having an aspect ratio, that is, a ratio of the maximum length to the minimum length of 0.3 or more and 1.0 or less. The average particle size of the particles is preferably 50 μm or more and 800 μm or less, more preferably 100 μm or more and 600 μm or less, and still more preferably 200 μm or more and 500 μm or less.

In addition, the liquid absorber 10 may contain components other than the components described above. Examples of such components include a surfactant, a lubricant, an antifoaming agent, a filler, an anti-blocking agent, a UV absorber, a colorant such as a pigment and a dye, a flame retardant, and a fluidity improver.

### Filling Method

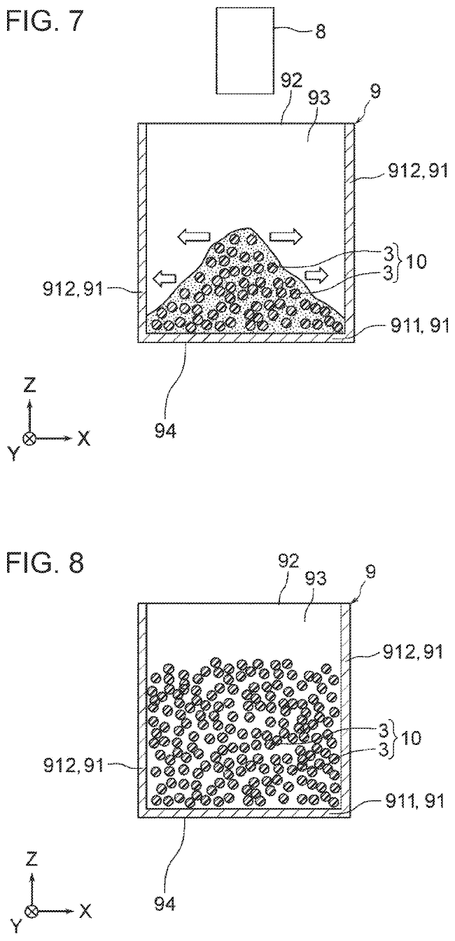

FIG. 6 is a flowchart illustrating a filling method according to the first embodiment. FIGS. 7 and 8 are views for describing the filling method illustrated in FIG. 6.

The filling method illustrated in FIG. 6 is a method of filling the container 9 with the liquid absorber 10 using the filling apparatus 100. Specifically, the filling method is a method of filling the container 9 having the shape as described above, that is, the container 9 provided with the interior space 93, the opening 92 that allows the interior space 93 to communicate with the outside, and the bottom surface 94, with the liquid absorber 10 having the water absorbent resin 3 capable of absorbing the liquid. Such a filling method includes a charging step S1 for charging the liquid absorber 10 from the opening 92 toward the interior space 93, and a vibration step S2 for applying vibration to the container 9 in which the liquid absorber 10 is charged. The vibration applied to the container 9 is taken as a vibration plane formed in an angle range in which the angle to the horizontal plane is 0°±30° or less.

According to such a filling method, the liquid absorber 10 can be filled uniformly in a short time.

Hereinafter, each step will be described sequentially.

### [1] Charging Step S1

First, the liquid absorber 10 is fallen from the feeder 8 disposed above the opening 92 of the container 9 toward the interior space 93 and charged. The charged liquid absorber 10 is fallen by its own weight and accumulates in a heaped shape with the top directly below the feeder 8 in the interior space 93 as illustrated in FIG. 7.

### [2] Vibration Step S2

Next, vibration is applied to the container 9 in which the liquid absorber 10 is charged. As described above, this vibration is applied within an angle range in which the angle between the vibration plane and the horizontal plane is 0°±30° or less. As a result, the liquid absorber 10 swings in the interior space 93 horizontally. As illustrated in FIG. 8, the liquid absorber 10 is uniformly filled in the entire interior space 93 by vibration for a relatively short time.

### Second Embodiment

Next, a second embodiment will be described.

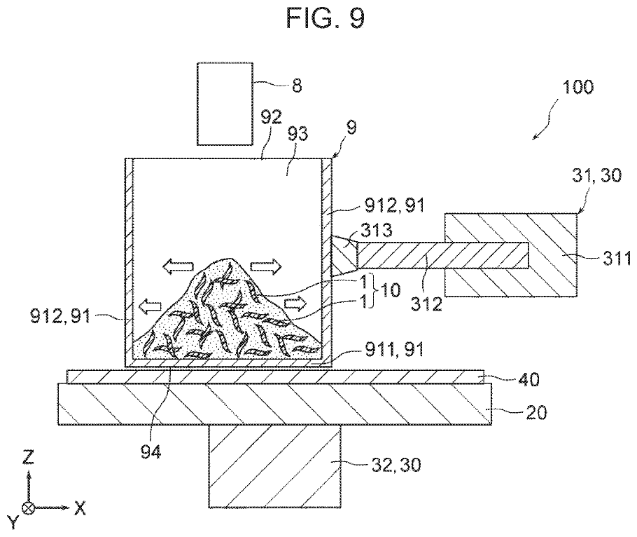

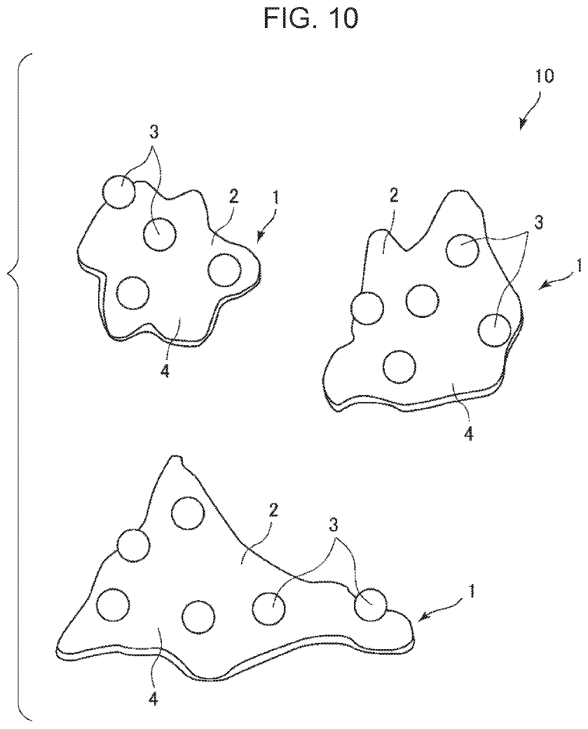

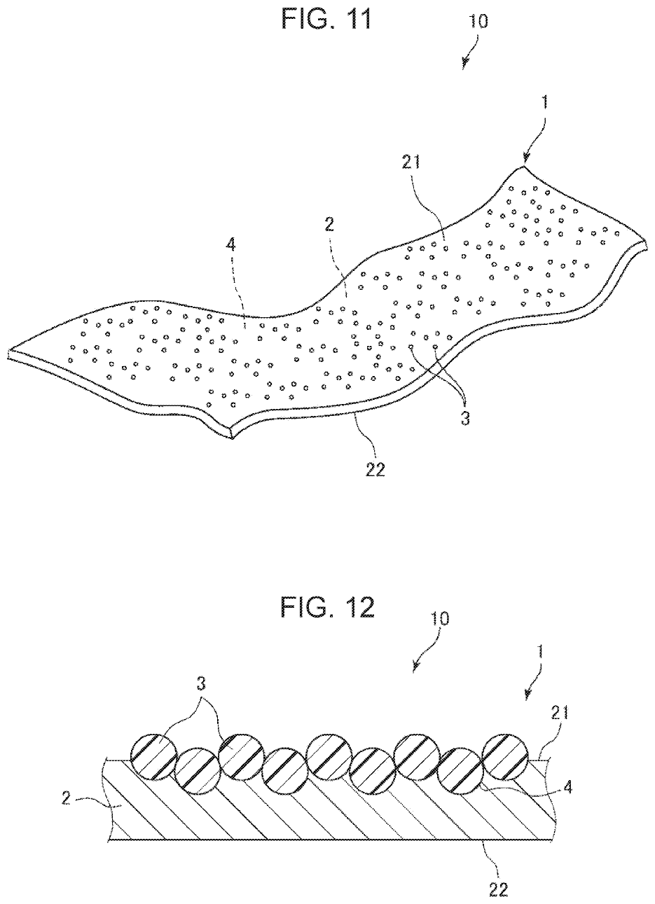

FIG. 9 is a cross-sectional view of a filling apparatus according to a second embodiment when cut along a plane parallel to a vertical direction. FIGS. 10 to 12 are views illustrating the liquid absorber 10 illustrated in FIG. 9, respectively. FIG. 10 and FIG. 11 are perspective views, respectively. FIG. 12 is a cross-sectional view.

The present embodiment is the same as the first embodiment described above except that the liquid absorber is different. In the following description, the present embodiment will be described with a focus on differences from the above-described embodiment, and description of similar matters will be omitted. In addition, in FIGS. 9 to 12, the same reference numerals are applied to the same configurations as those of the above-described embodiment.

As illustrated in FIG. 9, the liquid absorber 10 according to the present embodiment includes a small piece aggregate having a plurality of small pieces 1. Specifically, as illustrated in FIGS. 10 to 12, the liquid absorber 10 according to the present embodiment is configured to include the small piece aggregate provided with a plurality of small pieces 1 each having a fiber base material 2 containing fibers and the water absorbent resin 3. That is, the liquid absorber 10 according to the present embodiment further includes fibers.

As a result, when a liquid is applied to the small piece aggregate, the fiber base material 2 once holds the liquid in a state where a large number of opportunities for the small piece 1 to come into contact with the liquid can be ensured and a large contact area between the liquid and the small piece 1 can be ensured. Thereafter, the liquid can be efficiently fed from the fiber to the water absorbent resin 3, and the liquid absorption characteristics of the liquid absorber 10 as a whole can be improved.

In addition, since the liquid absorber 10 is configured to include the small piece aggregate provided with the plurality of small pieces 1, the shape can be changed freely. Therefore, a desired amount can be stored in the container 9 and the bulk density can be easily adjusted. As a result, it is possible to prevent unevenness in the liquid absorption characteristics.

Furthermore, it is preferable that at least a portion of the water absorbent resin 3 is impregnated in the fiber base material 2. As a result, it is difficult for the water absorbent resin 3 to be detached from the fiber base material 2. As a result, the above-described liquid absorption characteristics can be exhibited over a long period of time, and the water absorbent resin 3 can be prevented from falling off from the small piece 1 in the container 9. Therefore, it is possible to prevent the water absorbent resin 3 from being unevenly distributed in the container 9. As a result, it is possible to prevent unevenness in the liquid absorption characteristics.

In the small piece aggregate, the configuration of each small piece 1 is substantially the same as each other, and thus, one small piece 1 will be representatively described below.

As described above, the small piece 1 includes the fiber base material 2 containing fibers and the water absorbent resin 3. In addition, an adhesive 4 is interposed between the fiber base material 2 and the water absorbent resin 3. The adhesive 4 may be provided as necessary and may be omitted.

In addition, the water absorbent resin 3 is carried on one surface of the fiber base material 2, for example, the front surface 21 in FIG. 11. As a result, the liquid reached the front surface 21 can be absorbed, and the liquid reached a rear surface 22 can be rapidly propagated.

The water absorbent resin 3 may also be carried on the rear surface 22. In this case, the adhesion amount of the water absorbent resin 3 may be different between the front surface 21 and the rear surface 22. As a result, it can be achieved both absorption and propagation of liquid.

The fiber base material 2 suitably carries on the water absorbent resin 3 and more preferably prevents the water absorbent resin 3 from falling off. In addition, when the liquid is applied to the small piece 1, the fiber base material 2 once holds the liquid, and thereafter can be efficiently fed by the water absorbent resin 3, so that the liquid absorption characteristics of the small piece 1 as a whole can be improved. In addition, in general, fibers such as cellulose fibers, especially fibers derived from waste paper are less expensive than the water absorbent resin 3 and are advantageous from the viewpoint of reducing the manufacturing cost of the small pieces 1. In addition, it is advantageous from the viewpoints of waste reduction and effective use of resources.

Examples of the fibers include synthetic resin fibers such as polyester fibers and polyamide fibers, natural resin fibers such as cellulose fibers, keratin fibers, and fibroin fibers, and chemically modified products thereof. These may be used alone or in combination as appropriate. It is preferable to mainly use cellulose fibers, and it is more preferable that almost all of these are cellulose fibers.

Since cellulose is a material having suitable hydrophilicity, when the liquid is applied to the small piece 1, the liquid can be suitably taken in, a state with particularly high fluidity, for example, a state where the viscosity is 10 mPa·s or less can be rapidly removed, and the liquid once taken in can be suitably fed into the water absorbent resin 3. As a result, the liquid absorption characteristics of the small piece 1 as a whole can be made particularly excellent. In addition, since cellulose normally has a high affinity with the water absorbent resin 3, the water absorbent resin 3 can be more suitably carried on the front surface of fibers. In addition, the cellulose fiber is a natural material that can be recycled, and it is cheap and easy to obtain among various fibers. Therefore, it is advantageous from the viewpoints of reducing the production cost of the small piece 1, stable production, and reducing the environmental load.

In the present specification, the cellulose fiber may be a material having cellulose as a compound, that is, cellulose in a narrow sense as a main component, and a fibrous shape, and may contain hemicellulose and lignin in addition to cellulose.

The average length of the fibers is not particularly limited, and is preferably 0.1 mm or more and 7 mm or less, more preferably 0.1 mm or more and 5 mm or less, and still more preferably 0.1 mm or more and 3 mm or less. The average diameter of the fibers is not particularly limited, and is preferably 0.05 mm or more and 2 mm or less, and more preferably 0.1 mm or more and 1 mm or less.

The average aspect ratio of the fibers, that is, the ratio of the average length to the average width is not particularly limited, and is preferably 10 or more and 1,000 or less, and more preferably 15 or more and 500 or less.

With the numerical range as described above, the water absorbent resin 3 can be suitably carried on, the liquid can be suitably held by the fibers, and the liquid can be suitably fed into the water absorbent resin 3, and the liquid absorption characteristics of the small piece 1 as a whole can be made more excellent.

In addition, as illustrated in FIG. 12, the water absorbent resin 3 is carried on the front surface 21 of the fiber base material 2. In addition, the water absorbent resin 3 may partially enter the inside of the fiber base material 2. That is, the water absorbent resin 3 may be partially impregnated in the fiber base material 2. As a result, the carrying force with respect to the fiber base material 2 of the water absorbent resin 3 can be increased. The water absorbent resin 3 can be prevented from falling out in the container 9. As a result, the liquid absorption characteristics can be maintained for a long period of time, it is possible to prevent the water absorbent resin 3 from being unevenly distributed in the container 9, and to prevent unevenness in the liquid absorption characteristics.

In the present specification, “impregnation” refers to a state where at least a portion of the particles of the water absorbent resin 3 enter the inside of the fiber base material 2. In addition, all the particles may not be impregnated. In addition, the particles of the water absorbent resin 3 may penetrate the fiber base material 2 by softening.

The content of the water absorbent resin 3 in the small piece 1 is preferably 25% by mass or more and 300% by mass or less, and more preferably 50% by mass or more and 150% by mass or less of the fiber base material 2. As a result, the water absorption and permeability can be sufficiently ensured. When the content of the water absorbent resin 3 in the small piece 1 is too small, there is a possibility that the water absorption is insufficient. On the other hand, when the content of the water absorbent resin 3 in the small piece 1 is too large, the expansion rate of the small piece 1 tends to increase, and the permeability may be lowered.

In addition, the liquid absorber 10 according to the present embodiment may include the adhesive 4 as necessary. The adhesive 4 bonds the fiber base material 2 and the water absorbent resin 3 and also bonds the water absorbent resins 3 and fibers. As a result, the carrying force to the fiber base material 2 of the water absorbent resin 3 can be increased, and it is difficult for the water absorbent resin 3 to fall out of the fiber base material 2. Therefore, the effect described above can be exhibited more reliably.

The adhesion by the adhesive 4 can be replaced by adhesiveness or tackiness that is manifested by softening of the water absorbent resin 3 by contact between the water absorbent resin 3 and a liquid containing water when the small piece 1 is manufactured. That is, the function of the adhesive 4 is replaced by water.

When bonding by a method other than water, the adhesive 4 is not particularly limited, and a water-soluble adhesive, an organic adhesive, or the like can be used. Among these, the water-soluble adhesive is preferable. As a result, when the liquid is water-based, even if the water-soluble adhesive is attached to the front surface of the water absorbent resin 3, since the water-soluble adhesive dissolves when the liquid comes into contact with the adhesive 4, it is possible to prevent the water absorption by the water absorbent resin 3 from being inhibited by the water-soluble adhesive.

When a water-soluble adhesive is used as the adhesive 4, examples of the water-soluble adhesive include proteins such as casein, soybean protein, various starches such as starch and oxidized starch, polyvinyl alcohols containing modified polyvinyl alcohol such as polyvinyl alcohol, cationic polyvinyl alcohol, and silyl modified polyvinyl alcohol, cellulose derivatives such as carboxymethyl cellulose and methyl cellulose, aqueous polyurethane resins, aqueous polyester resins, and the like.

Among these adhesives, it is preferable to use polyvinyl alcohol from the viewpoint of front surface strength. As a result, the adhesive force between the fiber base material 2 and the water absorbent resin 3 can be sufficiently increased.

The above effect can be exhibited irrespective of the type of liquid by selecting the type of the adhesive 4 according to the type of liquid to be absorbed.

The content of the adhesive 4 in the small piece 1 is preferably 1.0% by mass or more and 70% by mass or less, and more preferably 2.5% by mass or more and 50% by mass or less with respect to the fiber. As a result, the effect of containing the adhesive 4 is acquired more significantly. When the content of the adhesive 4 is too small, the effect of containing the adhesive 4 is not significantly acquired. On the other hand, even when the content of the adhesive 4 is too large, the improvement of the carrying force of the water absorbent resin 3 is not acquired further significantly.

In addition, as illustrated in FIG. 11, it is preferable that each small piece 1 is flexible and has a long shape. As a result, each small piece 1 is easily deformed. When the aggregate of these small pieces 1 is stored in the container 9, each small piece 1 is deformed regardless of the shape inside the container 9, that is, the shape following property is exhibited. Therefore, the liquid absorber 10 can be collectively stored without difficulty. In addition, the contact area with the liquid as the liquid absorber 10 as a whole can be ensured more widely, and thus the absorption performance for absorbing the liquid is improved.

The aspect ratio between the total length and the width of the small piece 1 is preferably 1 or more and 200 or less, and more preferably 1 or more and 30 or less. The thickness of the small piece 1 is also preferably, for example, 0.05 m or more and 2 mm or less, and more preferably 0.1 mm or more and 1 mm or less.

The total length, that is, the length in the long side direction of the small piece 1 depends on the shape and size of the container 9, and is preferably 0.5 mm or more and 200 mm or less, more preferably 1 mm or more and 100 mm or less, and still more preferably 2 mm or more and 30 mm or less.

In addition, the width, that is, the length in the short side direction of the small piece 1 also depends on the shape and size of the container 9, and is preferably 0.1 mm or more and 100 mm or less, more preferably 0.3 mm or more and 50 mm or less, and still more preferably 1 mm or more and 20 mm or less, for example.

With the numerical range as described above, the water absorbent resin 3 can be suitably carried on, the liquid can be suitably held by the fiber base material 2, and the liquid can be suitably fed into the water absorbent resin 3, and the liquid absorption characteristics of the small piece 1 as a whole can be made more excellent. Furthermore, the liquid absorber 10 as a whole is easily deformed and has excellent shape followability to the container 9.

The small piece aggregate may include the small pieces 1 in which at least one of the length, width, aspect ratio, and thickness is the same as each other, or may include the small pieces 1 in which all of these are different from each other.

In addition, when the area of the front surface 21 of the fiber base material 2 of the small piece 1 is a [mm²] and the thickness of the front surface 21 in the normal direction is b [mm], the small piece 1 preferably satisfies the relationship of a^{1/2}/b>5 and 0.01≤b≤10.00. As a result, the small piece 1 has a sufficient contact area with the liquid and has excellent shape followability to the container 9.

The content of the small piece 1 having a maximum width of 3 mm or less in the small piece aggregate is preferably 30% by mass or more and 90% by mass or less, and more preferably 40% by mass or more and 80% by mass or less. As a result, it is possible to more effectively prevent unevenness in the liquid absorption characteristics.

If the content of the small piece 1 having a maximum width of 2 mm or less is too small, a gap is likely to be formed between the small pieces 1 when the small piece aggregate is stored in the container 9, and there is a possibility that unevenness of the liquid absorption characteristics occurs in the container 9. On the other hand, when the content of the small pieces 1 having a maximum width of 2 mm or less is too large, it tends to be difficult to form a gap between the small pieces 1 and it is unlikely to adjust the bulk density of the small piece aggregate.

In addition, the small pieces 1 preferably have a regular shape. That is, it is preferable that the small piece 1 is cut into a regular shape by a shredder or the like. As a result, unevenness is unlikely to occur in the bulk density of the small piece aggregate, and it is possible to prevent unevenness in the liquid absorption characteristics in the container 9. In addition, the small piece 1 cut into the regular shape can make the area of a cut surface as small as possible. Therefore, dust generation, that is, scattering of the fibers and the water absorbent resin 3 can be suppressed while ensuring an appropriate liquid absorption characteristics.

The “regular shape” refers to a shape such as a polygon such as a rectangle, a square, a triangle, and a pentagon, a circle, and an ellipse. In addition, each small piece 1 may have the same dimension as each other, or may be a similar shape. In addition, for example, in the case of a rectangle, even when the lengths of the sides are different, a regular shape is used as long as it is in the category of a rectangle.

The content of the small pieces 1 having such a regular shape is preferably 30% by mass or more, more preferably 50% by mass or more, and still more preferably 70% by mass or more of the whole small piece aggregate.

In addition, the small piece 1 may have an irregular shape. As a result, each small piece 1 is likely to be entangled, and is likely to maintain the shape of the whole small piece aggregate which can prevent that the small piece aggregate is divided or unevenly distributed. In addition, the small piece 1 having the irregular shape can increase the area of the cut surface as much as possible, and can increase the contact area with the liquid. Therefore, it contributes to rapid absorption of the liquid.

The “irregular shape” refers to as a shape other than the “regular shape” as described above, such as a rough cut shape or a shredded shape by hand as illustrated in FIG. 10, for example.

In addition, in the small piece aggregate, the small piece 1 of such a regular shape and the small piece 1 of the irregular shape may be mixed. As a result, both the effects described above can be shared.

In the container 9, the small pieces 1 are stored as an aggregate so that the extending directions of the small pieces 1 are not aligned with each other, that is, not parallel to each other. In other words, each small piece 1 is randomly stored in the container 9 in a three-dimensional direction.

In such a storage state, a gap is likely to be formed between the small pieces 1. As a result, the liquid can pass through the gap, and when the gap is very small, the liquid can be wet and spread by capillary action. As a result, liquid permeability can be ensured. In addition, since the liquid flowing downward in the container 9 is prevented from being dammed halfway, the liquid can be penetrated to the rear of the container 9, that is, the bottom portion 911. As a result, each small piece 1 can absorb the liquid without excess and deficiency, and can hold the liquid for a long period of time.

In addition, the bulk density of the liquid absorber 10 is preferably 0.01 g/cm³ or more and 0.5 g/cm³ or less, more preferably 0.03 g/cm³ or more and 0.3 g/cm³ or less. Among these, it is particularly preferably 0.05 g/cm³ or more and 0.2 g/cm³ or less. As a result, both the water retention and permeability of the liquid can be achieved.

When the bulk density of the liquid absorber 10 is too small, the content of the water absorbent resin 3 tends to decrease, and the liquid retainability may be insufficient. On the other hand, when the bulk density of the liquid absorber 10 is too large, the gap between the small pieces 1 cannot be sufficiently ensured, and the liquid permeability may be insufficient.

The liquid absorber 10 as described above can be manufactured, for example, as follows.

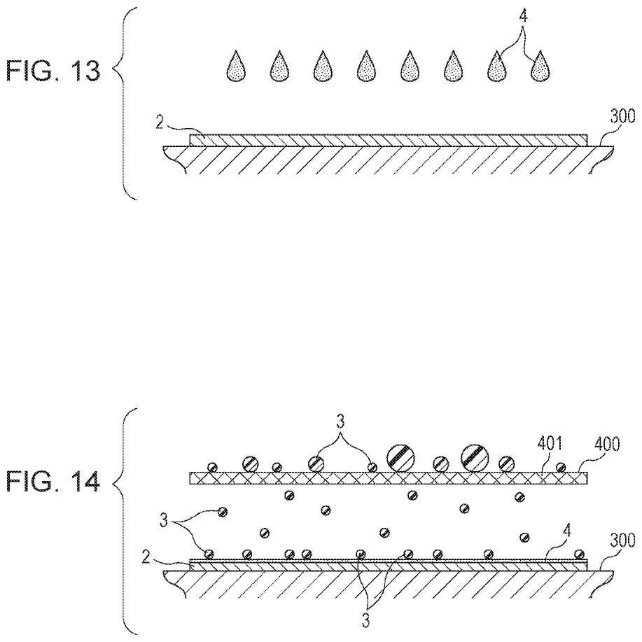

FIGS. 13 to 15 are diagrams for describing an example of a method of manufacturing the liquid absorber 10 illustrated in FIGS. 11 and 12, respectively. The manufacturing method described as an example includes a placement step, an adhesive application step, and a heating and pressing step.

First, as the placement step, as illustrated in FIG. 13, the sheet-like fiber base material 2 before being cut into small pieces 1 is placed on a placement table 300.

Next, as the adhesive application step, the adhesive 4 is applied to the front surface of the sheet-like fiber base material 2. Examples of the application method include application by spraying, a method in which the adhesive 4 is soaked in a sponge roller, and the sponge roller is rolled on the fiber base material 2.

Next, as illustrated in FIG. 14, the water absorbent resin 3 is applied to the fiber base material 2 through a mesh member 400. The mesh member 400 has a mesh 401. Among the water absorbent resin 3, particles larger than the mesh 401 are captured on the mesh member 400, while particles smaller than the mesh 401 pass through the mesh 401 and applied to the fiber base material 2.

Next, as illustrated in FIG. 15, the fiber base material 2 to which the water absorbent resin 3 is attached is disposed between a pair of heating blocks 500. As the heating and pressing step, the pair of heating block 500 is heated and pressurized in a direction where the pair of heating block 500 approaches, and the fiber base material 2 is pressurized in the thickness direction. As a result, the water absorbent resin 3 and the adhesive 4 are softened by heating, and the water absorbent resin 3 enters the inside of the fiber base material 2 by pressurization. Thereafter, by releasing the heating and pressurization, the adhesive 4 is dried, and the water absorbent resin 3 is adhered to the fiber base material 2 in a state of entering the inside of the fiber base material 2. Therefore, the water absorbent resin 3 is in a state of being impregnated in the fiber base material 2.

The applied pressure in this step is preferably 0.1 kg/cm² or more and 1.0 kg/cm² or less, and more preferably 0.2 kg/cm² or more and 0.8 kg/cm² or less. In addition, the heating temperature in this step is preferably 80° or higher and 160° or lower, and more preferably 100° or higher and 120° or lower.

For example, the sheet-like fiber base material 2 is finely cut, roughly crushed, and pulverized by scissors, a cutter, a mill, a shredder, or is shredded by hand to obtain the small piece aggregate made of the small pieces 1.

Here, a modification example of the liquid absorber 10 will be described.

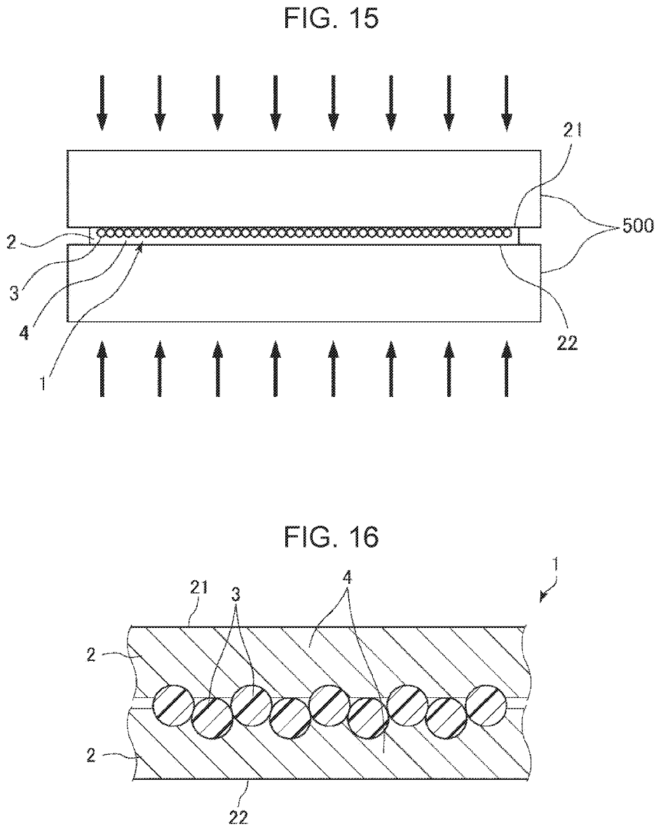

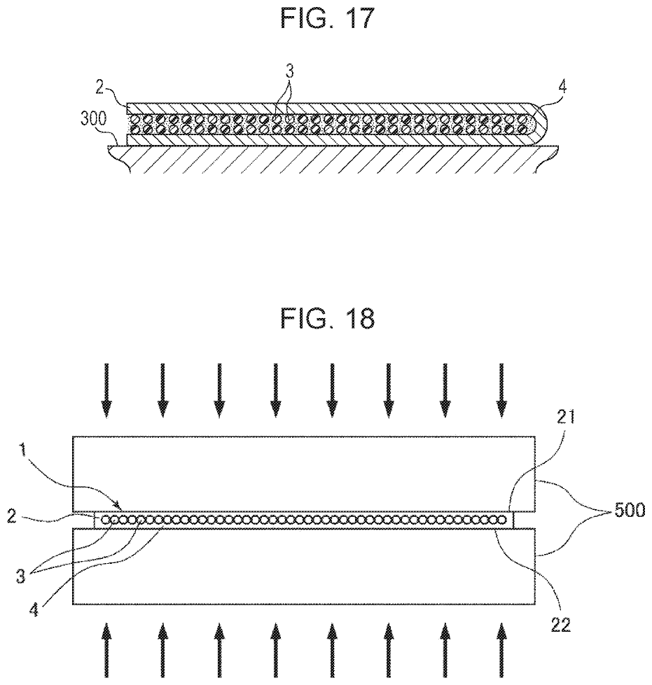

FIGS. 16 to 18 are views illustrating modification examples of the liquid absorber illustrated in FIGS. 11 and 12, respectively. FIG. 16 is a cross-sectional view of the small piece 1 included in the liquid absorber according to the modification example. FIGS. 17 and 18 are views for describing a method of manufacturing the small piece 1 illustrated in FIG. 16, respectively.

Hereinafter, the liquid absorber according to the modification example will be described with reference to these drawings. In the following description, differences from the above-described embodiment will be mainly described, and description of similar matters will be omitted.

The present modification example is the same as the above-described embodiment except that the configuration of the small piece 1 is different.

The small piece 1 illustrated in FIG. 16 has the two fiber base materials 2 stacked each other. The water absorbent resin 3 is provided between the fiber base materials 2. Therefore, the water absorbent resin 3 is particularly unlikely to fall off from the fiber base material 2 and can exhibit the liquid absorption characteristics for a longer period of time, and it is possible to more effectively prevent the water absorbent resin 3 from being unevenly distributed in the container 9.

The present modification example is not limited to the structure of illustration, and for example, the three or more fiber base material 2 may be stacked.

Next, a method of manufacturing the small piece 1 according to the modification example will be described.

The manufacturing method includes a placement step, an adhesive application step, a folding step, and a heating and pressing step. Since the placement step and the adhesive application step are the same as the steps described above, the description thereof will be omitted.

As illustrated in FIG. 17, the sheet-like fiber base material 2 undergone the placement step and the adhesive application step is folded in half as the folding step. At this time, it is folded in half so that the surface to which the water absorbent resin 3 is applied comes into contact.

Next, as illustrated in FIG. 18, the folded sheet-like fiber base material 2 is disposed between the pair of heating blocks 500. As the heating and pressing step, the pair of heating block 500 is heated and pressurized in a direction where the pair of heating block 500 approaches, and the fiber base material 2 is pressurized in the thickness direction. As a result, the water absorbent resin 3 and the adhesive 4 are softened by heating, and the water absorbent resin 3 enters the inside of the fiber base material 2 by pressurization. In addition, the water absorbent resins 3 that are folded and overlapped are also softened and bonded.

By releasing the heating and pressurization, the adhesive 4 is dried, and the water absorbent resin 3 is adhered to the fiber base material 2 in a state of entering the inside of the fiber base material 2. The water absorbent resin 3 is in a state of being impregnated in the fiber base material 2, and the fiber base material 2 folded and overlapped is bonded by the water absorbent resin 3 and the adhesive 4.

The small piece 1 is obtained by cutting the fiber base material 2 folded and adhered in this manner.

According to the manufacturing method as described above, the fiber base material 2 can be configured to be stacked by a simple method in which the water absorbent resin 3 and the adhesive 4 are applied to a single fiber base material 2 and folded. That is, the operation of applying the water absorbent resin 3 and the adhesive 4 to the two fiber base materials 2 can be omitted, respectively. Therefore, the manufacturing step can be simplified.

### Filling Method

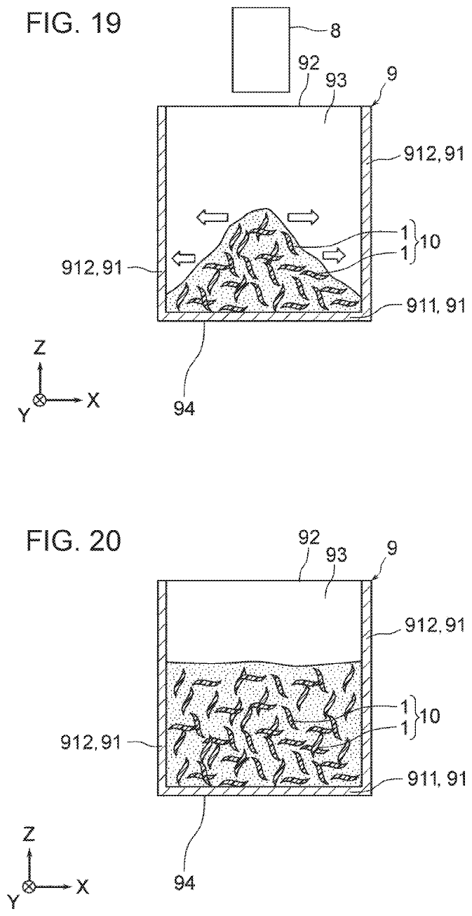

FIGS. 19 and 20 are views for describing a filling method by the filling apparatus illustrated in FIG. 9, respectively.

### [1] Charging Step S1

First, the liquid absorber 10 is fallen from the feeder 8 disposed above the opening 92 of the container 9 toward the interior space 93 and charged. The charged liquid absorber 10 is fallen by its own weight and accumulates in a heaped shape with the top directly below the feeder 8 in the interior space 93 as illustrated in FIG. 19. In particular, since the liquid absorber 10 including the small piece 1 has low fluidity, it is difficult to flow by its own weight at this point.

### [2] Vibration Step S2

Next, vibration is applied to the container 9 in which the liquid absorber 10 is charged. As described above, this vibration is applied within an angle range in which the angle between the vibration plane and the horizontal plane is 0°±30° or less. As a result, the liquid absorber 10 swings in the interior space 93 horizontally, for example. As illustrated in FIG. 20, the liquid absorber 10 is uniformly filled in the entire interior space 93 by vibration for a relatively short time.

### Third Embodiment

Next, a third embodiment will be described.

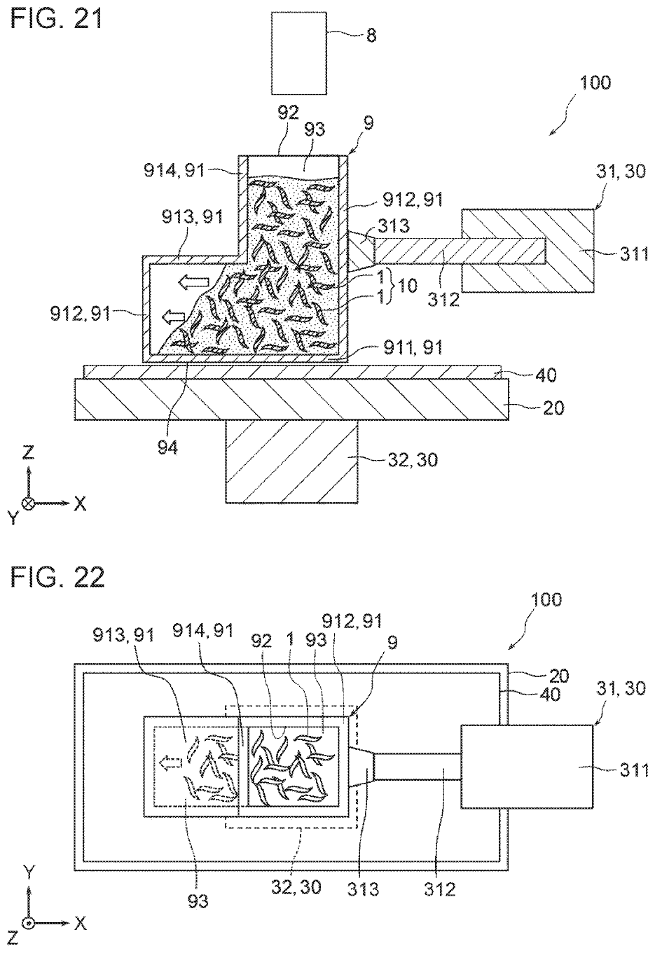

FIG. 21 is a cross-sectional view of a filling apparatus according to a third embodiment when cut along a plane parallel to a vertical direction. FIG. 22 is a top view of the filling apparatus illustrated in FIG. 21 when viewed from vertically above.

The present embodiment is the same as the above-described embodiment except that the shape of the container is different. In the following description, the present embodiment will be described with a focus on differences from the above-described embodiment, and description of similar matters will be omitted. In addition, in FIGS. 21 and 22, the same reference numerals are applied to the same configurations as those in the above-described embodiment.

The wall portion 91 of the container 9 illustrated in FIG. 21 includes the bottom portion 911 having the bottom surface 94 as a main surface on the vertically lower side, the side portion 912 erected upward from an edge of the bottom portion 911, a ceiling portion 913 extending from the upper end of the side portion 912 in parallel to the bottom portion 911, and a side portion 914 erected upward from the edge of the ceiling portion 913. A region surrounded by the upper ends of the side portions 912 and 914 corresponds to the upper end of the interior space 93 and is the opening 92 that communicates the interior space 93 with the outside.

The container 9 provided with such a wall portion 91 has the opening 92 smaller than the bottom surface 94 as illustrated in FIGS. 21 and 22. Therefore, as illustrated in FIG. 22, the interior space 93 of the container 9 has a portion that does not overlap the opening 92 when viewed from vertically above. That is, when the areas of the cross sections parallel to the horizontal plane are compared, the area of a portion of the interior space 93 is larger than the area of the opening 92.

The container 9 having such a shape can ensure a large overall volume even when the area of the opening 92 is small. Therefore, in the apparatus in which the container 9 is incorporated, even when the opening 92 is required to be reduced due to interference with members other than the container 9, a sufficient volume can be ensured without sacrificing the volume of the interior space 93. Therefore, a large amount of the liquid absorber 10 can be ensured, and more liquid can be absorbed. In addition, since the center of gravity of the container 9 having such a shape is located vertically below, the container 9 is easily self-supporting and does not easily fall down. Therefore, there also is an advantage that the handling of the container 9 is easy.

On the other hand, in such a container 9, it is particularly difficult to spread the liquid absorber 10 over the entire interior space 93 only by charging the liquid absorber 10 through the opening 92. Specifically, when the container 9 is viewed from vertically above, the liquid absorber 10 is unlikely to move to a portion of the interior space 93 that does not overlap the opening 92. The filling apparatus 100 according to the present embodiment efficiently moves the liquid absorber 10 to such a portion of the interior space 93 by applying vibration to the container 9, and the entire interior space 93 can be filled with the liquid absorber 10 uniformly and in a short time in.

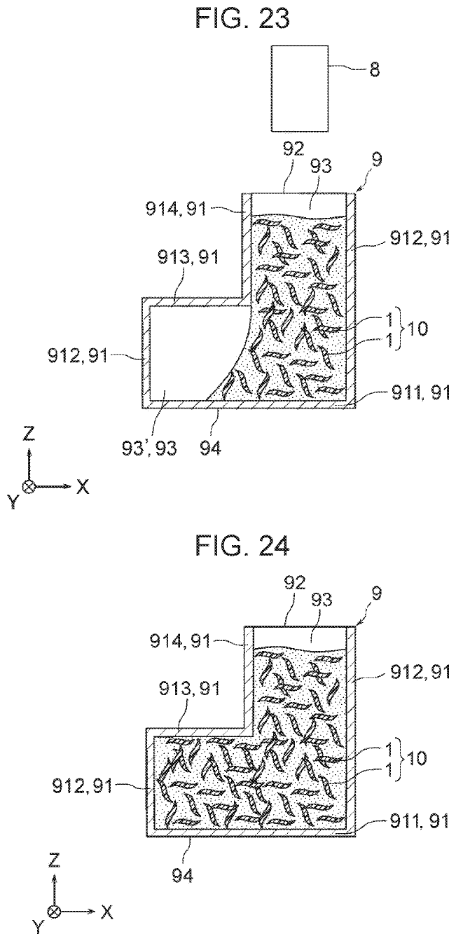

FIGS. 23 and 24 are views for describing a filling method according to the third embodiment.

### [1] Charging Step S1

First, the liquid absorber 10 is fallen from the feeder 8 disposed above the opening 92 of the container 9 toward the interior space 93 and charged. The charged liquid absorber 10 is fallen by its own weight and accumulates in a heaped shape with the top directly below the feeder 8 in the interior space 93 as illustrated in FIG. 23.

On the other hand, in the interior space 93, a portion 93′ that does not spread over even when the liquid absorber 10 is charged is generated. Such a portion 93′ is a portion that does not overlap the opening 92 in the interior space 93 when the container 9 is viewed from the vertical direction, for example. The liquid absorber 10 does not spread over the portion 93′ only by charging the liquid absorber 10 through the opening 92 in many cases.

In the container 9, the volume of the portion 93′ is preferably 10% or more, more preferably 30% or more and 500% or less of the entire volume of the interior space 93. Since the volume of the entire interior space 93 is unlikely to be restricted by the size and position of the opening 92, such a container 9 has a particularly high degree of freedom in shape, and has particularly good incorporation into the apparatus.

In addition, in the case of the container 9 illustrated in FIG. 21, furthermore, a volume V14 of the portion pinched between the side portions 912 and 914 is smaller than a volume V12 of the other portion, that is, the portion pinched between the side portions 912, and it is preferable that V14/(V14+V12) is 0.2 or more. As a result, after the charged liquid absorber 10 is once received by the former portion, that is, the volume V14 portion, the liquid absorber 10 is moved to the latter portion, that is, the volume V12 portion with the application of vibration. It can be moved gradually. Therefore, even when the amount of the liquid absorber 10 is large, the liquid absorber 10 can be filled efficiently.

### [2] Vibration Step S2

Next, vibration is applied to the container 9 in which the liquid absorber 10 is charged. As described above, this vibration is such that a plane in which the angle to the horizontal plane is 30° or less is the vibration plane. Therefore, the liquid absorber 10 swings in the interior space 93 in a plane close to the horizontal. The liquid absorber 10 starts moving also in the portion 93′ described above. By continuing the vibration for a relatively short period of time, as illustrated in FIG. 24, the portion 93′ is also filled with the liquid absorber 10, and the entire interior space 93 is uniformly filled with the liquid absorber 10.

Although the frequency of vibration applied to the container 9 is not particularly limited, the frequency is preferably 0.5 Hz or more, and more preferably 10 Hz or more and 100 Hz or less. By setting the frequency of vibration within the above range, the small piece 1 can be efficiently swung from the viewpoint of the average natural frequency of the small piece 1. Therefore, filling of the liquid absorber 10 can be completed in a shorter time.

In addition, although the amplitude of vibration applied to the container 9 is not particularly limited, the amplitude is preferably 25% or more and 300% or less of the average length of the small pieces 1 (average length of the liquid absorber 10 having small piece shape), and more preferably 50% or more and 300% or less. By setting the amplitude of vibration within the above range, the small piece 1 can be efficiently swung from the viewpoint of the average natural frequency of the small piece 1. Therefore, filling of the liquid absorber 10 can be completed in a shorter time. The average length of the small piece 1 means a value obtained by averaging the length of the small piece 1 with 10 or more pieces.

### Fourth Embodiment

Next, a fourth embodiment will be described.

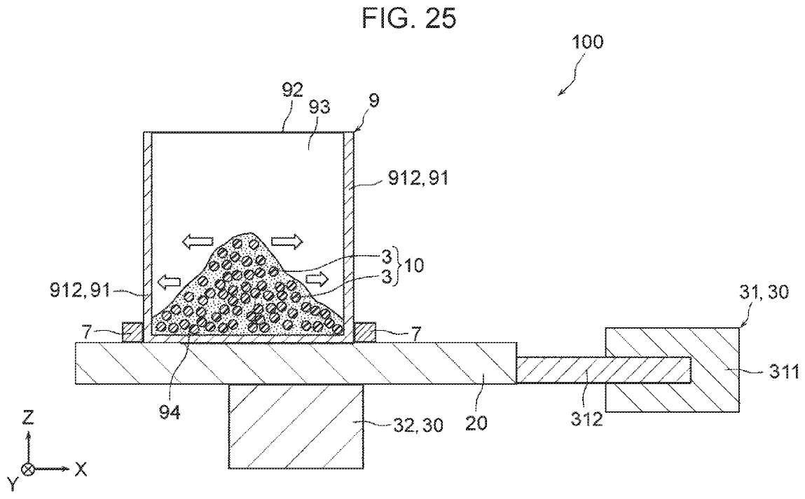

FIG. 25 is a cross-sectional view of a filling apparatus according to a fourth embodiment when cut along a plane parallel to a vertical direction.

The present embodiment is the same as the above-described embodiment except that the configuration of the first axial direction vibration portion 31 is different. In the following description, the present embodiment will be described with a focus on differences from the above-described embodiment, and description of similar matters will be omitted. In addition, In FIG. 25, the same reference numerals are applied to the same configurations as those of the above-described embodiment.

The first axial direction vibration portion 31 illustrated in FIG. 25 is configured to vibrate the container 9 by vibrating the stage 20 instead of the container 9. Specifically, the rod 312 provided in the first axial direction vibration portion 31 is in contact with the end surface of the stage 20. Therefore, when the first axial direction vibration portion 31 is operated, the first axis vibration is applied to the stage 20, and the first axis vibration is also applied to the container 9 accordingly.

In addition, the stage 20 is provided with a container holding portion 7. The container holding portion 7 is provided on both the X axis plus side and the X axis minus side of the container 9. Therefore, the container 9 is held in a state pinched by the two container holding portions 7. As a result, when the first axis vibration is applied to the stage 20, the container 9 can be forcibly swung accordingly. In the fourth embodiment as described above, the same effect as that of the above embodiment can be obtained.

### Fifth Embodiment

Next, a fifth embodiment will be described.

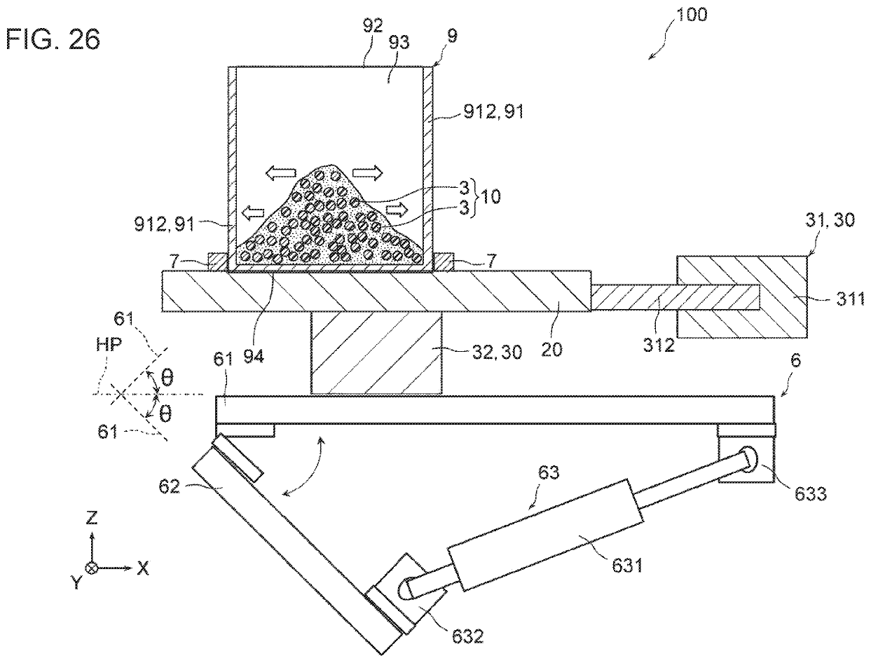

FIG. 26 is a cross-sectional view of a filling apparatus according to a fifth embodiment when cut along a plane parallel to a vertical direction.

The present embodiment is the same as the above-described embodiment except that the configuration of the filling apparatus 100 is different. In the following description, the present embodiment will be described with a focus on differences from the above-described embodiment, and description of similar matters will be omitted. In addition, in FIG. 26, the same reference numerals are applied to the same configurations as those in the above-described embodiment.

The filling apparatus 100 illustrated in FIG. 26 is provided with a fourth axial direction vibration portion 6 in addition to the configuration of the apparatus illustrated in FIG. 25.

The fourth axial direction vibration portion 6 has a function of applying a vibration that reciprocally rotates around the Y axis with the Y axis as a rotation axis in the X-Z plane. Specifically, the fourth axial direction vibration portion 6 illustrated in FIG. 26 is provided with a plate-like base portion 61, a plate-like inclined plate 62, and a clevis cylinder 63. A rotation axis of reciprocating rotation applied by the fourth axial direction vibration portion 6 is not limited to the Y axis, and may be the X axis. Here an example in which the Y axis is the rotation axis will be described.

The base portion 61 is disposed so that the second axis direction vibration portion 32 is placed on the upper surface thereof. That is, the second axial direction vibration portion 32 is supported from vertically below by the upper surface of the base portion 61.

In addition, the stage 20 is supported by the second axial direction vibration portion 32, and the first axial direction vibration portion 31 abuts on the stage 20. Therefore, the stage 20 and the first axial direction vibration portion 31 are also placed on the base portion 61.

The inclined plate 62 is fixed to a floor or a base (not illustrated). One end portion of the inclined plate 62 is coupled to the end portion of the base portion 61 on the X axis minus side. The coupling portion is rotatable, and is configured such that the angle formed between the base portion 61 and the inclined plate 62 can be freely changed. On the other hand, the other end portion of the inclined plate 62 is coupled to one end portion of the clevis cylinder 63.

The clevis cylinder 63 is provided with a cylinder main body 631, a clevis fitting 632 provided at one end portion thereof, and a clevis fitting 633 provided at the other end portion. The cylinder main body 631 and the inclined plate 62 are coupled to each other via the clevis fitting 632. In addition, the cylinder main body 631 and the end portion of the base portion 61 on the X axis plus side are coupled to each other via a clevis fitting 633. As a result, the other end portion of the inclined plate 62 and the end portion of the base portion 61 on the X axis plus side are coupled to each other via the clevis cylinder 63.

In such a clevis cylinder 63, the reciprocating motion of the cylinder main body 631 is converted into a rotational motion in the clevis fittings 632 and 633. That is, the clevis fitting 632 is driven so that the angle formed between the inclined plate 62 and the cylinder main body 631 is changed, and the clevis fitting 633 is driven so that the angle formed between the cylinder main body 631 and the base portion 61 is changed. As a result, the clevis cylinder 63 is driven to generate a vibration in which the angle formed by the base portion 61 and the inclined plate 62 is changed. In the fourth axial direction vibration portion 6, a vibration generated based on such a principle, that is, a fourth axis vibration that reciprocates around the Y axis is applied to the stage 20 and the container 9.

Therefore, in addition to the first axis vibration and the second axis vibration described above, the fourth axis vibration is applied to the container 9. The first axis vibration, the second axis vibration, and the fourth axis vibration may be applied in synchronization with each other or may be applied asynchronously.

As an example, in the state illustrated in FIG. 26, the upper surface of the base portion 61 is parallel to the X-Y plane and is also parallel to a horizontal plane HP. When the clevis cylinder 63 contracts from this state, the base portion 61 rotates clockwise in FIG. 26 and the end portion of the base portion 61 on the X axis plus side is displaced downward. Thereafter, when the clevis cylinder 63 is extended, the base portion 61 is now rotated counterclockwise in FIG. 26 and the upper surface returns to a state parallel to the horizontal plane HP. When the clevis cylinder 63 is further extended, the base portion 61 further rotates counterclockwise, and the end portion of the base portion 61 on the X axis plus side is displaced upward beyond the horizontal plane HP. By repeating the rotation as described above, the fourth axis vibration is generated.

In generating such fourth axis vibration, the stroke of the clevis cylinder 63 is set so that the angle θ formed by the upper surface of the base portion 61 and the horizontal plane HP is within 30°. As a result, the fourth axis vibration can be applied to the container 9 without departing from the angle range in which the angle formed by the vibration plane and the horizontal plane HP is within 0°±30°.

The vibration pattern in the fourth axis vibration is not particularly limited and includes various patterns. For example, in the state illustrated in FIG. 26, that is, in a state where the base portion 61 and the horizontal plane HP are parallel to each other, when the angle θ is 0° and the base portion 61 rotates counterclockwise there from, it is assumed that the angle θ formed between the horizontal plane HP and the upper surface of the base portion 61 is positive. When the base portion 61 rotates clockwise, it is assumed that the angle θ formed between the horizontal plane HP and the upper surface of the base portion 61 is negative. As a result, examples of the vibration patterns in the fourth axis vibration include various patterns such as a pattern that rotates so that the angle θ reciprocates between 0° and +30°, a pattern that rotates so that the angle θ reciprocates between 0° and −30°, a pattern that rotates so that the angle θ reciprocates between +10° and −10°, a pattern in which the angle θ rotates counterclockwise from 0° to +30°, thereafter rotates clockwise to −10°, and again rotates clockwise to +5°.

Furthermore, examples of another patterns include (1) a pattern that applies only the first axis vibration, (2) a pattern that applies only the second axis vibration, (3) a pattern that applies only the fourth axis vibration, (4) a pattern that simultaneously applies the first axis vibration and the second axis vibration, (5) a pattern that simultaneously applies the second axis vibration and the fourth axis vibration, (6) a pattern that simultaneously applies the first axis vibration and the fourth axis vibration, (7) a pattern that simultaneously applies the first axis vibration, the second vibration, and the fourth axis vibration.

In addition, among the patterns (1) to (7) described above, any two or more patterns may be appropriately selected, and vibration may be applied by a composite pattern combined so that the selected patterns are switched at a predetermined time period. An example of the composite pattern is a pattern in which (1) to (7) described above are sequentially applied in a cycle of one second.

Also in the fifth embodiment as described above, the same effect as in the above embodiment can be obtained. In addition, in the present embodiment, the vibration of the fourth axis, that is, the vibration of reciprocating rotation around the Y axis is added, so that the movement of the liquid absorber 10 is further promoted and the liquid absorber 10 can be uniformly filled in a shorter time.

As described above, although the filling apparatus and the filling method of this disclosure are described based on embodiment of illustration, this disclosure is not limited thereto.

For example, the shape of the container to be filled with the liquid absorber in the embodiment may be any shape.

In addition, the liquid which a liquid absorber absorbs is not particularly limited, and examples thereof include printing ink. Therefore, the container filled with the liquid absorber is incorporated in, for example, an ink jet printer and used as a waste ink tank for absorbing and holding waste ink.

### EXAMPLE

Next, specific examples of the present disclosure will be described.

### 1. Filling Liquid Absorber

### Example 1

### [1] Manufacture of Liquid Absorber

First, a waste paper having a length of 30 cm, a width of 22 cm, and a thickness of 0.5 mm was prepared as a sheet-like fiber base material. The average length of fibers contained in this waste paper was 0.71 mm, the average width was 0.2 m, and the aspect ratio defined by the average length/average width was 3.56. In addition, the weight of the waste paper was 4 g/one sheet.

Next, a small amount of water was sprayed on one side of the waste paper with a spray.

Next, as a partial sodium salt cross-linked product of a polyacrylic acid polymer cross-linked product, which is a water absorbent resin having a carboxyl group as an acid group in the side chain, SUNFRESH 500MPSA manufactured by Sanyo Chemical Industries, Ltd. was applied from a surface side of the waste paper sprayed with water. At this time, the water absorbent resin was applied while passing through a sieve having a mesh with a mesh size of 0.106 mm, specifically, JTS-200-45-106 manufactured by Tokyo Screen Co., Ltd. The coating amount of the water absorbent resin was 4 g.

The waste paper was folded in half so that a valley was formed on the surface to which the water absorbent resin adhered. In this folded state, the folded waste paper was pressurized and heated in the thickness direction using a pair of heating blocks. The pressurization was performed at 0.3 kg/cm² and the heating temperature was 100° C. In addition, the time which performed heating and pressurization was 2 minutes.

When heating and pressurization were released and the folded waste paper reached a room temperature, the folded waste paper was cut into small pieces of 2 mm×15 mm. As a result, a liquid absorber formed of an aggregate of small pieces was obtained. The content of the water absorbent resin in the small piece was 50% by weight, and the average particle diameter of the water absorbent resin was 35 to 50 μm. In addition, the average fiber length was 25 mm. In addition, in each small piece, the water absorbent resin was impregnated in the fiber base material.

[2] Charging Liquid Absorber into Container and Vibration

Next, the liquid absorber was charged from the opening of the container illustrated in FIGS. 21 and 22.

Next, the container filled with the liquid absorber was placed on the filling apparatus illustrated in FIGS. 21 and 22, and the vibration represented by the translation vectors illustrated in FIG. 3 was applied for 10 seconds. That is, the first axis vibration and the second axis vibration are vibrations each having the horizontal plane as the vibration plane, and these are applied in a time division manner.

The positional relation between both was set so that the direction of the first axis vibration is parallel to the major axis of the bottom surface of the container, that is, the angle between the direction of the first axis vibration and the major axis of the bottom surface was 0°. The frequency of the vibration which combined the first axis vibration and the second axis vibration was 50 Hz, and the amplitude of vibration was 40% of the average length of the small piece contained in the liquid absorber.

### [3] Measurement of Filling Rate

Next, the side surface of the container was captured with a camera to obtain an image. On the image, the area of the portion filled with the liquid absorber and the area not filled with the liquid absorber were calculated. The ratio of the area of the portion filled with the liquid absorber to the area of the entire interior space was determined, and this was used as the filling rate.

### Examples 2 to 15

The container was filled with the liquid absorber and the filling rate was determined in the same manner as in Example 1 except that the conditions of vibration by the filling apparatus were changed as illustrated in Table 1.

### Examples 16 and 17

The container was filled with the liquid absorber and the filling rate was determined in the same manner as in Examples 1 and 2, except that the container was changed to that illustrated in FIG. 9.

### Examples 18 and 19

The container was filled with the liquid absorber and the filling rate was determined in the same manner as in Examples 1 and 2, except that only the particulate water absorbent resin was used as the liquid absorber, and the container was changed to that illustrated in FIG. 1.

### Comparative Examples 1 and 2

The container was filled with the liquid absorber and the filling rate was determined in the same manner as in Example 1 except that the conditions of vibration by the filling apparatus were changed as illustrated in Table 1.

### Comparative Example 3

The container was filled with the liquid absorber and the filling rate was determined in the same manner as in Comparative Example 1, except that the container was changed to that illustrated in FIG. 9.

### Comparative Example 4

The container was filled with the liquid absorber and the filling rate was determined in the same manner as in Comparative Example 1, except that only the particulate water absorbent resin was used as the liquid absorber, and the container was changed to that illustrated in FIG. 1.

### 2. Evaluation of Filling Rate

The filling rate obtained in each example and each comparative example was evaluated in light of the following evaluation criteria.

### Evaluation Criteria of Filling Rate

A: The filling rate is 98% or more

B: The filling rate is 95% or more and less than 98%

C: The filling rate is 90% or more and less than 95%

D: The filling rate is 80% or more and less than 90%

E: The filling rate is less than 80%

The evaluation results are illustrated in Table 1.

TABLE 1

| | | | Conditions of vibration by filling apparatus | | | | |
|---|---|---|---|---|---|---|---|
| | | | Angle between | | Ratio of amplitude | Positional relation | |
| | | | normal of vibration | | of vibration to | of vibration direction | |
| | | | plane and vertical | Frequency of | average length of | to bottom surface | Evaluation results |
| | Liquid absorber | Container | direction | vibration | small piece | of container | Filling rate |
| | — | — | ° | Hz | % | ° | — |
| Example 1 | Small piece aggregate | FIG. 19 | 0 | 50 | 40 | 0 | A |
| Example 2 | Small piece aggregate | FIG. 19 | 15 | 50 | 40 | 0 | B |
| Example 3 | Small piece aggregate | FIG. 19 | 30 | 50 | 40 | 0 | C |
| Example 4 | Small piece aggregate | FIG. 19 | 0 | 10 | 40 | 0 | B |
| Example 5 | Small piece aggregate | FIG. 19 | 0 | 30 | 40 | 0 | A |
| Example 6 | Small piece aggregate | FIG. 19 | 0 | 50 | 40 | 0 | A |
| Example 7 | Small piece aggregate | FIG. 19 | 0 | 70 | 40 | 0 | A |
| Example 8 | Small piece aggregate | FIG. 19 | 0 | 100 | 40 | 0 | B |
| Example 9 | Small piece aggregate | FIG. 19 | 0 | 50 | 25 | 0 | B |
| Example 10 | Small piece aggregate | FIG. 19 | 0 | 50 | 50 | 0 | B |
| Example 11 | Small piece aggregate | FIG. 19 | 0 | 50 | 5 | 0 | C |
| Example 12 | Small piece aggregate | FIG. 19 | 0 | 50 | 100 | 0 | C |
| Example 13 | Small piece aggregate | FIG. 19 | 0 | 50 | 40 | 15 | B |
| Example 14 | Small piece aggregate | FIG. 19 | 0 | 50 | 40 | 30 | B |
| Example 15 | Small piece aggregate | FIG. 19 | 0 | 50 | 40 | 45 | C |
| Example 16 | Small piece aggregate | FIG. 9 | 0 | 50 | 40 | 0 | A |
| Example 17 | Small piece aggregate | FIG. 9 | 15 | 50 | 40 | 0 | B |
| Example 18 | Particulate resin | FIG. 1 | 0 | 50 | 40 | 0 | B |
| Example 19 | Particulate resin | FIG. 1 | 15 | 50 | 40 | 0 | C |
| Comparative | Small piece aggregate | FIG. 19 | 45 | 50 | 40 | 0 | D |
| Example 1 | | | | | | | |
| Comparative | Small piece aggregate | FIG. 19 | 90 | 50 | 40 | 0 | E |
| Example 2 | | | | | | | |
| Comparative | Small piece aggregate | FIG. 9 | 45 | 50 | 40 | 0 | D |
| Example 3 | | | | | | | |
| Comparative | Particulate resin | FIG. 1 | 45 | 50 | 40 | 0 | E |
| Example 4 | | | | | | | |

As is apparent from Table 1, it was confirmed that each example had a higher filling rate than that of the comparative example. Therefore, according to the present disclosure, it was recognized that the liquid absorber can be filled in a short time without being biased with respect to the container. In addition, it was also recognized that the filling rate could be increased by optimizing the frequency and amplitude of vibration and the positional relation between the container and the vibration direction.

What is claimed is:

1. A filling apparatus that fills a container provided with an interior space, an opening through which the interior space and the outside communicate with each other, and a bottom surface, with a liquid absorber having a water absorbent resin absorbing a liquid, the apparatus comprising:
a stage on which the container is placed; and
a vibration applying portion that applies a vibration to the container placed on the stage, wherein
the vibration is applied as a vibration plane formed in an angle range in which an angle to a horizontal plane is within 0°±30°.

2. The filling apparatus according to claim 1, wherein
a frequency of the vibration is 0.5 Hz or more and 100 Hz or less.

3. The filling apparatus according to claim 1, wherein
the vibration applying portion applies a vibration in a first direction and a vibration in a second direction in a time division manner, when two directions intersecting each other in a plane of the vibration plane are defined as the first direction and the second direction.

4. The filling apparatus according to claim 3, wherein
an angle between a principal axis of inertia of the bottom surface and a translation vector representing the vibration in the first direction is 30° or less, when the translation vector is projected onto the bottom surface.

5. The filling apparatus according to claim 1, wherein
the vibration applying portion simultaneously applies a vibration in a first direction and a vibration in a second direction, when two directions intersecting each other in a plane of the vibration plane are defined as the first direction and the second direction.

6. The filling apparatus according to claim 5, wherein
the bottom surface has a polygonal shape,
an angle between a diagonal line of the bottom surface and a combined vector of a translation vector representing the vibration in the first direction and a translation vector representing the vibration in the second direction is 30° or less, when the combined vector is projected onto the bottom surface.

7. The filling apparatus according to claim 1, wherein
the vibration applying portion alternately repeats a first vibration pattern that applies a vibration in a first direction and a vibration in a second direction in a time division manner and a second vibration pattern that simultaneously applies the vibration in the first direction and the vibration in the second direction, when two directions intersecting each other in a plane of the vibration plane are defined as the first direction and the second direction.

8. The filling apparatus according to claim 1, wherein
the container has a portion in which the interior space does not overlap the opening when viewed from a vertical direction.

9. The filling apparatus according to claim 1, wherein
the liquid absorber further includes a fiber.

10. The filling apparatus according to claim 1, wherein
the liquid absorber has a small piece shape.

11. A filling method of filling a container provided with an interior space, an opening through which the interior space and the outside communicate with each other, and a bottom surface, with a liquid absorber having a water absorbent resin absorbing a liquid, the method comprising:
a charging step of charging the liquid absorber from the opening toward the interior space; and
a vibration step of applying a vibration to the container in which the liquid absorber is charged, wherein
the vibration is applied to the container as a vibration plane formed in an angle range in which an angle to a horizontal plane is within 0°±30° in the vibration step.

12. The filling method according to claim 11, wherein
an amplitude of the vibration is 25% or more and 300% or less of an average length of the liquid absorber.
